(19) United States
(12) Patent Application Publication
(10) Pub. No.: US 2008/0008105 A1
(43) Pub. Date: Jan. 10, 2008

(54) USER-CONTROLLED TELECOMMUNICATIONS SYSTEM

(75) Inventors: Jeffery D. Black, Menlo Park, CA (US); John H. Todd, Portland, OR (US)

Correspondence Address: FISH & RICHARDSON, PC, P.O. BOX 1022, MINNEAPOLIS, MN, 55440-1022, US

(73) Assignee: TALKPLUS, INC., a Delaware corporation

(21) Appl. No.: 11/775,185

(22) Filed: Jul. 9, 2007

Related U.S. Application Data
(63) Continuation of application No. 11/286,310, filed on Nov. 23, 2005.
(60) Provisional application No. 60/631,002, filed on Nov. 24, 2004.
(60) Provisional application No. 60/718,620, filed on Sep. 19, 2005.

(51) Int. Cl. H04L 12/16; H04Q 11/00

(52) U.S. Cl. 370/260

(57) ABSTRACT

Disclosed are systems and methods that enable an end user to control the parameters, behavior, and identity of network communications regardless of the limitations placed upon these controls by the end user's communications device or communications service provider. An intermediate media proxy resides on a telecommunications network and accepts inbound and outbound communications to and from a network communication device. The intermediate media proxy functions as an intermediary for network communications that occur between the network communications device and other network communications devices. In this manner, the intermediate media proxy can control various features of the communications independent of limitations enacted by the end user's communications device or communications service provider.

### REFERENCE TO PRIORITY DOCUMENT

This application is a continuation (and claims the benefit of priority under 35 USC § 120) of U.S. patent application Ser. No. 11/286,310, filed Nov. 23, 2005, which claims priority of U.S. Provisional Patent Application Ser. No. 60/631,002, filed Nov. 24, 2004 and U.S. Provisional Patent Application Ser. No. 60/718,620, filed Sep. 19, 2005. Priority of the aforementioned filing dates is hereby claimed, and the disclosures of the patent applications are hereby incorporated by reference in their entirety.

### BACKGROUND

There is currently an explosive growth in the use of telecommunications devices, particularly wireless telecommunication devices such as mobile phones. Telecommunications services for such devices are usually provided by a communications service provider that provides the devices with access to a telecommunications network for making inbound and outbound communications. In a typical scenario, the telecommunications service provider, such as a cellular carrier, provides a subscriber with the telecommunications device and also provides services associated with the device. For example, the cellular carrier can provide a subscriber with a cell phone and with communications services that permit the cell phone to make and receive telephone calls over the carrier's network.

One drawback of such a system is that the subscriber is bound by limitations and rules that are set up by the communication service provider. In the example of a cell phone subscriber, the subscriber must typically use a cell phone device that is authorized by the cellular provider. Consequently, the subscriber's use of the cell phone is limited by the capabilities of the devices provided by the cellular provider. Moreover, the cellular service provider controls the behavior and features with respect to inbound and outbound telephone calls made on the service provider's network.

It would be advantageous for a user of telecommunications devices to be able to control the features of inbound and outbound communications regardless of the limitations places on such communications by a service provider.

### SUMMARY

Disclosed are systems and methods that enable an end user to control the parameters, behavior, and identity of network communications regardless of the limitations placed upon these controls by the end user's communications device or communications service provider. An intermediate media proxy resides on a telecommunications network and accepts inbound and outbound communications to and from a network communication device. The network communications device can be any device that can communicate with a telecommunications network. The intermediate media proxy functions as an intermediary for network communications that occur between the network communications device and other network communications devices. In this manner, the intermediate media proxy can control various features of the communications independent of limitations enacted by the end user's communications device or communications service provider. The intermediate media proxy can also re-direct communications between two specified communications devices without the direct knowledge of either party involved in the communication as to the origin, destination, or characteristics of the communication.

The network that is used by the end user (as an example, a cellular carrier) is used only so far as to connect the communications device (e.g., a cell phone, instant message platform, video terminal, etc.) to the intermediate media proxy over a first communication leg. At that point, the intermediate media proxy is instructed (or has previously been instructed, through manual request or automatically executed rules) to create a second communication leg of the same or similar type to another endpoint. This new communication leg may have a different identity than the first leg per the user's request, or may have certain features which the originating leg did not allow. Such features as applied by the intermediate media proxy may be controlled in-band (via the media, such as spoken words, touch tones, instant message key words, or similar methods) or out of band (via some other network, such as an IP protocol which communicates with a user-driven application on the same device or via a third party interface, or by other interaction) by the user. Moreover, in a conference call scenario, each participant in the conference call can be connected pursuant to a different protocol.

This method may be used for both outbound and inbound communications in a similar fashion, except that for inbound communications the control is still in the hands of the “customer” (receiving number) and the originating party has no knowledge or control over the methods of communication completion.

In one aspect, there is disclosed a method and device for controlling communications of an end user, comprising receiving a communication signal at an intermediate media proxy, the communication signal inbound or outbound relative to at least one telecommunications network that is controlled by an entity separate from the intermediate media proxy; and controlling the communication signal, wherein the control is independent of limitations enacted by the entity that controls the at least one telecommunications network.

In another aspect, there is disclosed an intermediate media proxy, comprising telecommunications equipment communicatively coupled to a telecommunications network, wherein the telecommunication equipment is configured to receive network communication signals over the network, wherein the intermediate media proxy enables an end user to control parameters, behavior, and identity of the network communication signals regardless of limitations enacted by an end user's communications device or communications service provider.

In another aspect, there is disclosed a method of establishing a conference call, comprising identifying two or more participants of a conference call; providing a conference call notification to each of the two or more participants, wherein the conference call notification includes an identifier descriptive of an originator of the conference call; and varying the identifier for each participant that receives the notification.

In another aspect, there is disclosed a method of initiating a conference call, comprising presenting a graphical user interface (GUI) on handset, wherein the GUI includes at least one field for providing a conference call participant and at least one field for providing an originating identification to be displayed in a notification to the conference call participant, the originating identification associated with an originator of the conference call.

The details of one or more implementations are set forth in the accompanying drawings and the description below. Further features, aspects, and advantages will become apparent from the description, the drawings, and the claims.

### BRIEF DESCRIPTION OF THE DRAWINGS

FIG. 1A shows a high-level, schematic diagram of an exemplary embodiment of a telecommunications network that enables communications between devices communicatively connected to the network in accordance with the present disclosure.

FIG. 1B shows a schematic diagram that illustrates an exemplary scheme for handling incoming communications to a telecommunications device.

FIG. 1C shows a schematic diagram that illustrates exemplary process for handling outbound communications from a telecommunications device.

FIGS. 1D-1F shows several flow charts that describe alternate methods for initiating outbound communications via an alias service provider.

FIG. 1G shows an exemplary embodiment of a telecommunications network that can effectuate user-selective call.

FIG. 2 shows a flow diagram that represents an exemplary method that enables a subscriber of an alias service to configure the information that is provided to a called party pursuant to a caller configuration system.

FIG. 3A shows an exemplary wireless telephone equipped with an application and a contact database that reside on the telephone.

FIGS. 3B and 3C show an exemplary configurations of inbound and outbound filter databases.

FIG. 4 shows another exemplary embodiment of a telecommunications network that can effectuate-selective call configuration in accordance with the present disclosure.

FIG. 5 shows a schematic representation of a proximity-based predictive dialing scenario.

FIG. 6 shows a flow diagram that represents an exemplary method that enables a subscriber of the alias service to configure the information that is provided to a called party pursuant to a caller configuration system.

FIG. 7A shows an exemplary series of user interfaces that define a Rules Engine for the alias service.

FIG. 7B shows an exemplary flow diagram relating to age verification features of the alias service provider.

FIGS. 8 and 9 show a series of exemplary user interfaces that can be shown on a display screen of the phone to effectuate the user provided configuration information for an outgoing call.

FIG. 10 shows an exemplary series of user interfaces that allow a phone user to initiate a multi-way conference call.

FIG. 11 shows an exemplary user interface for a call history manager that displays call history information that can be grouped pursuant to received calls that pertain to a call profile or group.

FIG. 12 shows series of exemplary user interfaces that can be used to set-up and manage profiles.

FIG. 13 shows a series of user interfaces that permit a user to access and manage voicemail messages.

FIG. 14 shows a series of exemplary user interfaces for configuring background noise for calls implemented by the disclosed system.

FIG. 15 shows an exemplary series of user interfaces for setting up proximity based dialing parameters.

FIG. 16 shows a series of user interfaces that can be used to manage a Selective Do-Not-Disturb feature.

FIG. 17 is a schematic diagram that illustrates the implementation of filters for inbound calls.

### DETAILED DESCRIPTION

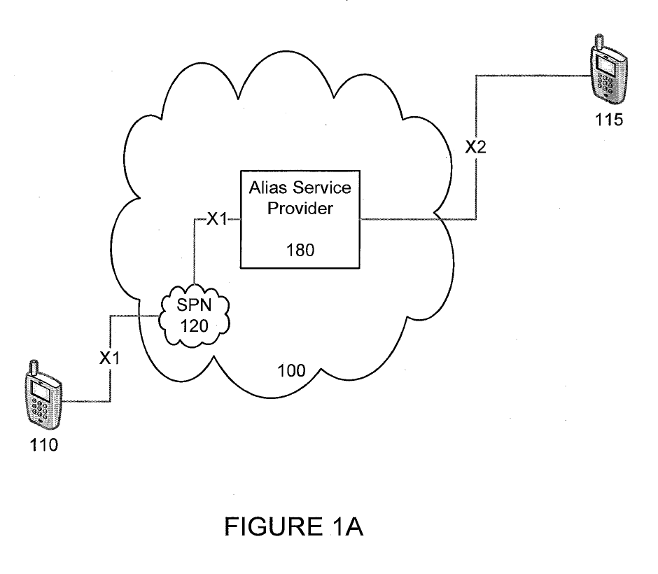

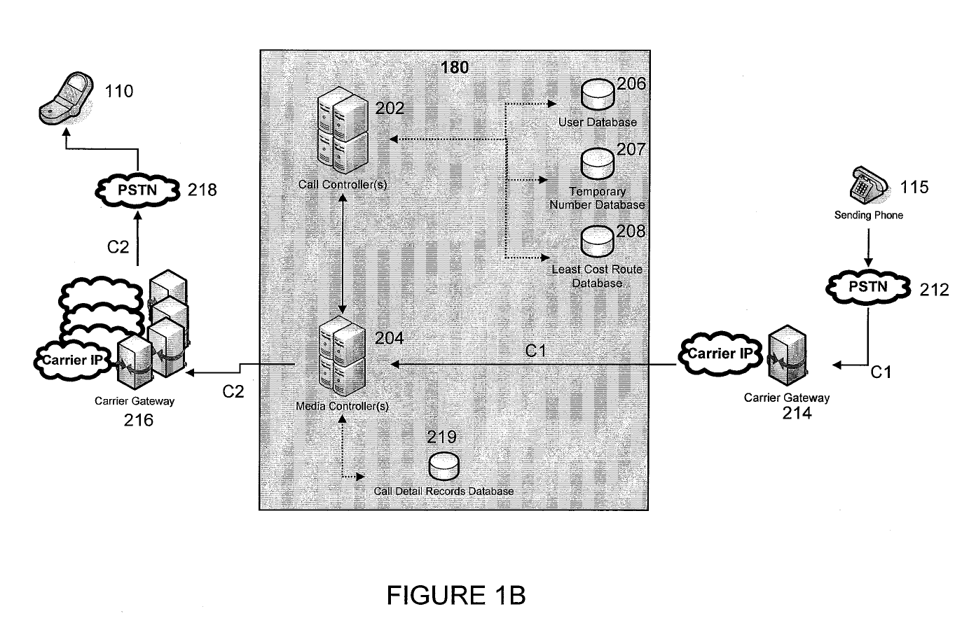

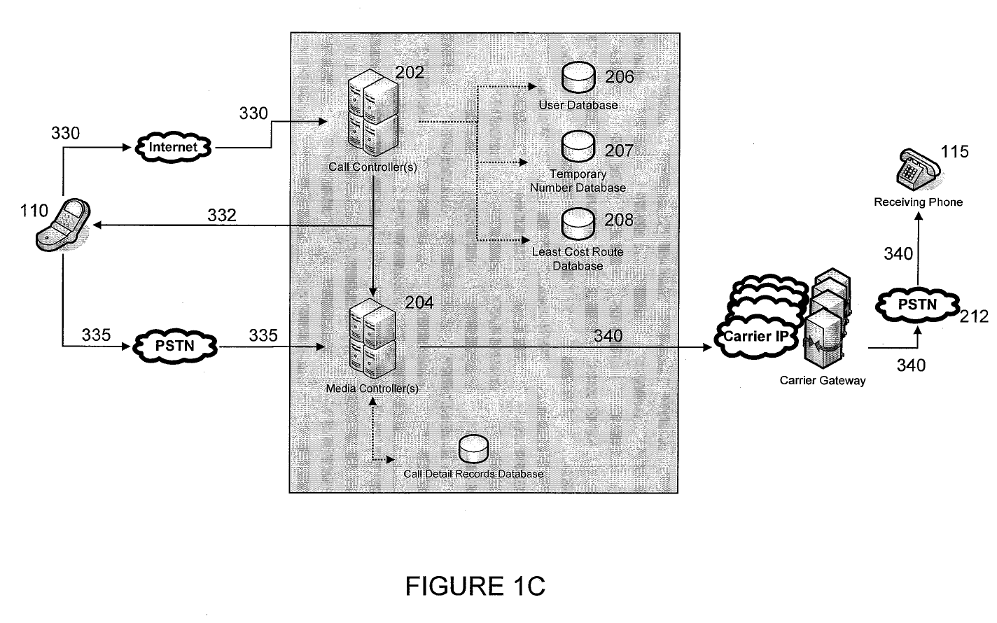

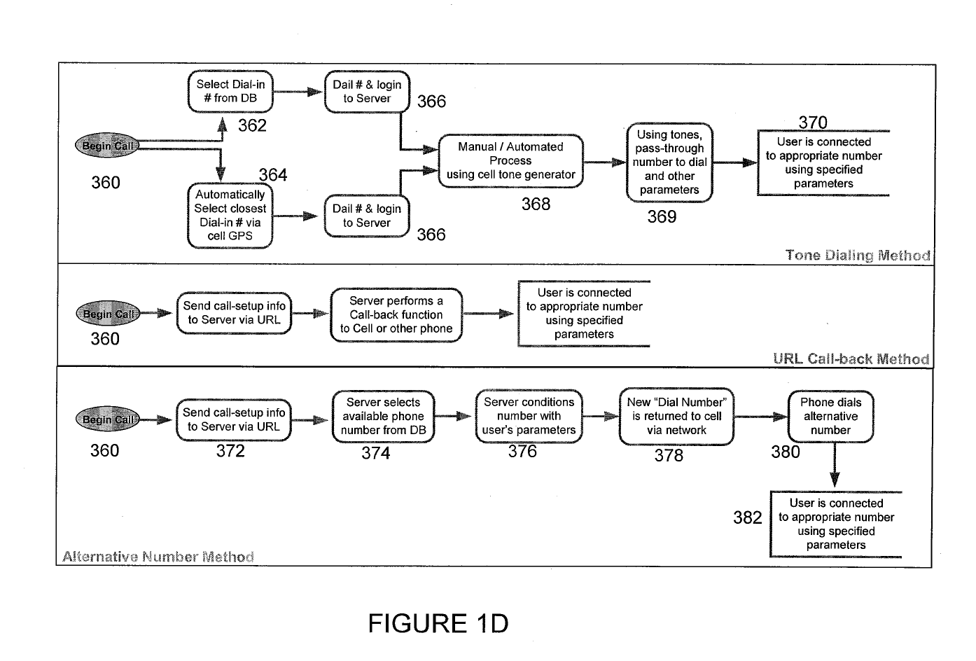

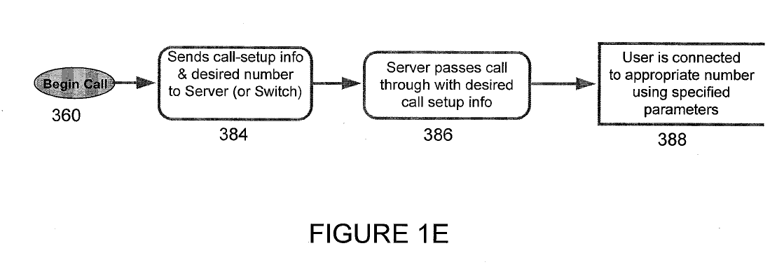

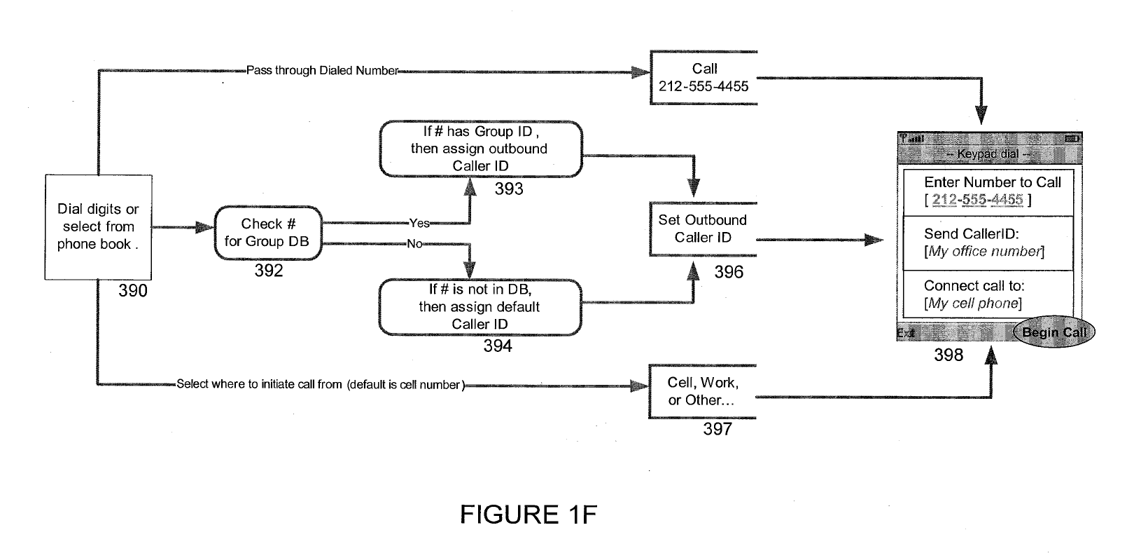

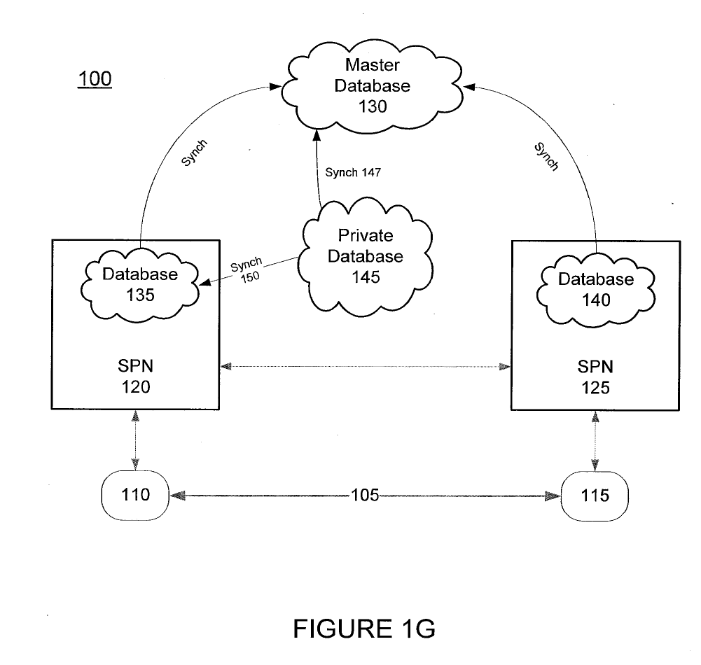

FIG. 1A shows a high-level, schematic diagram of an exemplary embodiment of a telecommunications network 100 that enables communications between devices communicatively connected to the network in accordance with the present disclosure. The network 100 can comprise, for example, a common or private bi-directional telecommunications network (e.g., a public switched telephone network (PSTN), cellular network, a cable-based telecommunication network, a LAN, a WAN, a wireless network, or combinations thereof), coupled with or overlayed by a TCP/IP network (e.g., the Internet or an intranet).

At least a first telecommunications device 110 and a second telecommunications device 115 are communicatively linked to the network 100. The telecommunications devices can be any type of devices that are configured to communicate with the network and to establish communication links with one another over the network 100. The telecommunications devices are described herein the in context of being a first wireless telephone 110 and a second wireless telephone 115, although the type of communications device can vary. For example, the telecommunications devices can be anything (e.g., computers, personal digital assistants, land-line telephones, etc.) configured to transmit and receive any type of data over a network.

Each telecommunications device has at least one address that points to a network location where a communication link can be established with the telecommunications device via the network 100. Throughout this disclosure, the network devices are sometimes described in the context of being telephones with one or more addresses comprised of telephone numbers. It should be appreciated, however, that the addresses of the communications devices are not limited to telephone numbers, but can include other types of addresses, such as, for example, a Session Initiated Protocol (SIP) Uniform Resource Identifier (URI), an instant message nickname, a shorthand descriptor of a group of other addresses, or any identifier that points to a location or node on the network where a communication link can be established.

The network 100 includes or is coupled to one or more Service Provider Networks (SPNs) 120 that provide communication services to the telephones 110 and 115. An SPN may be, for example, a Local Exchange Carrier (LEC), a Competitive Local Exchange Carrier (CLEC), a wireless telephony carrier, a VoIP provider, or any other network which provides endpoint-to-endpoint communications between subscribing devices such as the telephones 110, 115. Each telephone 110 and 115 is associated with an SPN 120 such that the SPN provides communication access to and over the network 100. The telephones 110 and 115 can both be associated with a common SPN or can each have a different SPN. For each telephone, the respective SPN provides one or more addresses (referred to as base addresses), such as base telephone numbers, that point to the telephones and that can be used to establish communication links over the network. The SPN typically limits the configuration or behavior of communications links that the telephones establish over the network 100.

With reference still to FIG. 1A, an alias service provider 180 (also referred to as an intermediate media proxy) resides within the network 100 or is otherwise communicatively linked to the network 100. The alias service provider 180 can includes equipment to enable network communication, such as, for example, servers, call controllers, database equipment, computer processors, memory, etc. The equipment can include computer-readable medium having computer-readable data that includes instructions for performing the processes described herein. The alias service provider 180 is configured to accept communications that the telephones 110 or 115 make over the network to provide control over the communication regardless of the limitations placed upon these controls by the SPN 120 associated with the telephones 110 and 115. Such control can include, for example, control over the parameters, behavior, and identity of the communications, as described more fully below.

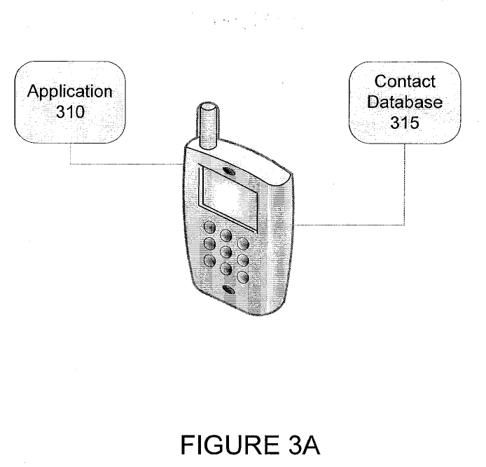

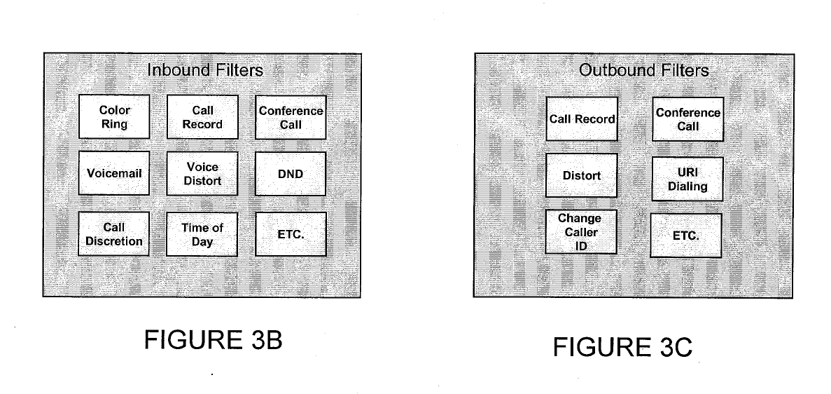

In order to provide such communications-related services, the alias service provider 180 establishes a service contract with an owner of a telecommunications device such as the telephone 110 or with a SPN. The telephone 110 can optionally be equipped with one or more applications provided by the alias service provider 180 (such as an application 310 shown in FIG. 3A) to enable the services. In addition, the alias service provider 180 can provide the telephone 110 with one or more additional addresses (referred to as alias addresses), such as alias telephone numbers, that are controlled by the alias service provider 180 rather than the SPN associated with the telephone 110. This enables the alias service provider 180 to control communications related to the alias addresses.

In an alternate embodiment, the alias service provider 180 and the SPN 120 are the same entity or are both controlled by the same entity. In such a case, both the base address(es) and the alias address(es) are provided by that entity. In other embodiments, the application 310 resides on a device other than the telephone 110, such as on a personal computer. A subscriber is able to access the alias service provider via the personal computer using the application. The subscriber would be able to generate and define communications using the application.

In an exemplary context, the alias service provider 180 provides the telephone 110 with one or more alias telephone numbers and an entity controlling the SPN 120 provides one or more base telephone numbers. Each of the base telephone number and the one or more alias telephone numbers can be used by the telephone 110 to access the network 100 for making and receiving communications such as inbound and outbound calls. However, inbound and outbound calls for the alias telephone numbers can be uniquely configured via the alias service provider 180, as described below. As mentioned, the addresses are not necessarily telephone numbers and the communications are not necessarily telephone calls. Other types of addresses and communications over the network are within the scope of this disclosure.

FIG. 1A provides a high level representation of how the alias service provider enables user-defined control of outbound and inbound communications of the telephone 110 regardless of the limitations placed upon the communications by the SPN 120 of the telephone 110. An outbound communication X1 is initiated by the telephone 110 to an address, such as a telephone number, associated with the telephone 115. As mentioned, the address being a telephone number is merely an example. The network devices do not have to be telephones and the address is not necessarily a telephone number but can be some other type of address.

The outbound communication X1 at least initially passes through the SPN 120. Prior to reaching the telephone 115, the outbound communication X1 is at least partially controlled by the alias service provider 180, which lies somewhere in the network 100 between the telephones 110 and 115. In an exemplary embodiment, the telephone 110 establishes an initial communication link to the alias service provider prior to sending the outbound communication to the address on the telephone 115. Pursuant to the initial communication link, the telephone provides the alias service provider with information relating to the upcoming outbound communication to the telephone 115. The telephone 110 then initiates (via the alias service provider) the outbound communication X1 to the telephone 115. An exemplary scheme for enabling the alias service provider to control the outbound communication is described below.

The alias service provider 180 thus establishes control over the outbound communication X1. In this regard, the alias service provider 180 can configure the communication X1 to enable various features described below, some of which are not permitted or enabled if the communication X1 were handled exclusively by the SPN 120. The alias service provider 180 then establishes a communication link X2 with the telephone 115. The communication link X2 can pass through an additional SPN associated with the telephone 115.

At this stage, a communication link X1 exists between the telephone 110 and the alias service provider 180, and a communication link X2 exists between the alias service provider 180 and the telephone 115. The alias service provider 180 then establishes a two-way communication link between the telephone 110 and the telephone 115 with the alias service provider having some control over the configuration of the communication link. Advantageously, this scheme permits the alias service provider 180 to provide communication-related features regardless of the limitations placed by the SPN 120. As mentioned, a specific scheme for handling outbound communications from the telephone 110 is described in more detail below.

The alias service provider 180 can also control inbound communications to an address associated with the telephone 110, such as an inbound call to a telephone number of the telephone 110. The telephone number can be an alias number that the alias service provider 180 assigned to telephone 110 wherein the alias service provider has control over that alias telephone number. Inbound calls to the alias telephone number automatically link to the alias service provider.

For example, with reference to FIG. 1A, the telephone 115 initiates an communication X2 toward an alias telephone number of the telephone 110. The communication X2 is directed to the alias service provider 180 because the alias service provider 180 has previously set-up the alias number to act in such a manner. The alias service provider 180 now has control over the inbound communication X2. Next, the alias service provider 180 establishes an inbound communication link X1 to the telephone 110, wherein the inbound communication link X1 may pass through the SPN 120. The alias service provider 180 then establishes a communication link between the telephones 110 and 115 with the communication link having features enabled by the alias service provider.

Exemplary Schemes for Inbound Communications

FIG. 1B shows a schematic diagram that illustrates an exemplary scheme for handling incoming communications to the telephone 110. For purposes of this example, an owner of the telephone 110 has subscribed to services provided by the alias service provider 180, which is positioned in a communication network so as to be able to control at least some communications between telephone 110 and telephone 115. The telephone 115 is not necessarily a service subscriber of the alias service provider 180.

FIG. 1B shows a schematic diagram that illustrates an exemplary scheme for handling incoming communications to the telephone 110. For purposes of this example, an owner of the telephone 110 has subscribed to services provided by the alias service provider 180, which is positioned in a communication network so as to be able to control at least some communications between telephone 110 and telephone 115. The telephone 115 is not necessarily a service subscriber of the alias service provider 180.

As mentioned, the telecommunications devices 110 and 115 do not necessarily have to be telephones. Moreover, although the example is sometimes described herein in the context of communication via telephone numbers, it should be appreciated that the disclosed processes can readily be used with other types of addresses, such as a SIP URI, an instant message nickname, etc. that are assigned to the telecommunications devices.

As mentioned, the alias service provider 180 assigns one or more, two or more, three or more, or any quantity of alias addresses to the telephone 110. In an exemplary context, the alias service provider 180 has assigned the telephone 110 with one or more alias telephone numbers that can be used to receive and send calls on the telephone 110. The alias numbers are in addition to a base telephone number that number(s) that was/were 120. It should be appreciated that the alias service provider control over a pool of alias addresses that can assign to subscribers. This permits the alias service provider to configure the addresses such that inbound communications to the addresses are automatically directed to the alias service provider. The alias service provider can then assign the addresses on a temporary or permanent basis to its subscribers.

With reference to FIG. 1B, the alias service provider 180 is located in communication network such that the alias service provider 180 can manage or access inbound and outbound communications to the telephone 110 particularly with respect to the alias numbers that are assigned to the telephone 110.

The alias service provider 180 includes various equipment for effectuating management of inbound and outbound calls. For example, the alias service provider 180 includes one or more call controllers 202, one or more media controllers 204, and one or more databases, such as a user database 206, a temporary or alias number database, a least cost route database 207, and a call detail records database 208. The databases can vary and can be used to store information related to the subscriber and the subscriber's telephone 110, as well as to store data that defines how the subscriber wants to manage inbound and outbound calls. The subscriber can advantageously transfer data related to subscriber's alias number(s) and call configuration data to a different telephone by connecting to the alias service provider over the network.

In the exemplary embodiment, the sending phone 115 initiates a communication, such as a telephone call C1, to the telephone 110. The call is initiated to an alias number that is assigned to the telephone 110 by the alias service provider 180. Because the alias service provider 180 assigned the number, the alias service provider 180 can control access to calls received through the number. The call can be routed, for example, through a PSTN 212 and a carrier gateway 214.

Upon receiving the call, the alias service provider 180 initially obtains information related to the subscriber that is associated with the alias service number that received the call. For example, the media controller 204 (or any device associated with the alias service provider) contacts the call controller 202 and sends information, such as the alias number, relating to the call. The call controller 202 communicates with one or more of the databases to obtain information that defines how to handle the call based on the alias number being called. In this regard, the controllers can consult a database of media filters that are used to configure various aspects of the inbound call once a communication link between the telephones 110 and 115 is established. The media filters define one or more features that are to be implemented on the inbound call. The features can vary, although some exemplary features are described below. The call controller 202 and media controller 204 can communicate back and forth as required. The media controller 204 can then act on the call based on the obtained information.

The media controller 204 then establishes a communication C2, such as a telephone call, to the telephone 110. The communication C2 can be routed through a carrier gateway 216 and a PSTN 218 associated with the telephone 110 so that the alias service provider 180 can communicatively connect to the telephone 110. If desired, the media controller can update a call details records database 219, such as for billing purposes.

When the telephone 110 receives the call, the alias service provider 180 provides a notification to the telephone (such as voice or text message) that provides an indication regarding which alias number the inbound call is associated with. As mentioned, the telephone 110 can have several alias address, so it is helpful for the subscriber to identify which alias address is receiving the call. A user may choose to turn off the profile notification message or turn on a prompt that asks the user if he/she would like to take the call. The user can also define rules that govern how the call is handled, such as to force the call to voicemail or automatically play a busy signal, etc.

In one embodiment, the telephone 110 rings and an identifying auditory message plays. For example, the message can say “You are receiving a call on line 3” (wherein line 3 is associated with an alias number). Alternately, there can be a unique ringtone associated with each base number and each alias number. Any other type of identifier can be used, such as a unique graphic being displayed, a unique vibration, an automatic auditory signal, etc.

Depending on whether the subscriber takes the call, the alias service provider 180 then establishes a two-way communication link between the telephone 110 and the telephone 115, or acts on the call based on filters that were previously defined by the subscriber and/or the alias service provider. During the pendancy of the communication between the telephones 110 and 115, the alias service provider can exert various levels of control over the call.

FIG. 3B shows an exemplary configuration of an inbound filters database. The inbound filters database includes data related to how the subscriber desires the alias service provider to handle inbound communications to addresses controlled by the alias service provider. The subscriber can specify on an address-by-address basis or rules based on groups of addresses, wherein the rules specify how an inbound communication for that address is handled. The filters database can include various data related to call handling, such as call recording (subject to legal requirements for recording calls), conference call features, voicemail treatment, etc., as described in detail below.

For example, a filter can specify that an inbound calls for alias number X is sent to a specific voicemail box with a predetermined greeting, while inbound calls for alias number Y is sent to a different voicemail box. In another example, a filter may be set to send all incoming calls for several different alias numbers (or specific calling numbers) to a single voicemail box where alias user or inbound number may receive a different voicemail greeting that was customized for that inbound number or alias number. In other words, a subscriber could have one voicemail box with multiple greetings that vary based on the alias number to which the call is directed.

For each address or group of addresses associated with the telephone, the user can define rules that govern handling of the incoming communication to that address. Some actions that can be performed include, for example, recording a call, automatically entering the call into a conference mode, inserting background noise into the call, causing the user's voice to distort during the call, setting a do-not-disturb for the call, varying the call response based on time of day or location of the telephone 110, etc. This permits the user to use a single telephone 110 to handle multiple telephone numbers while also varying the action taken for inbound calls based on the alias number to which the call is directed.

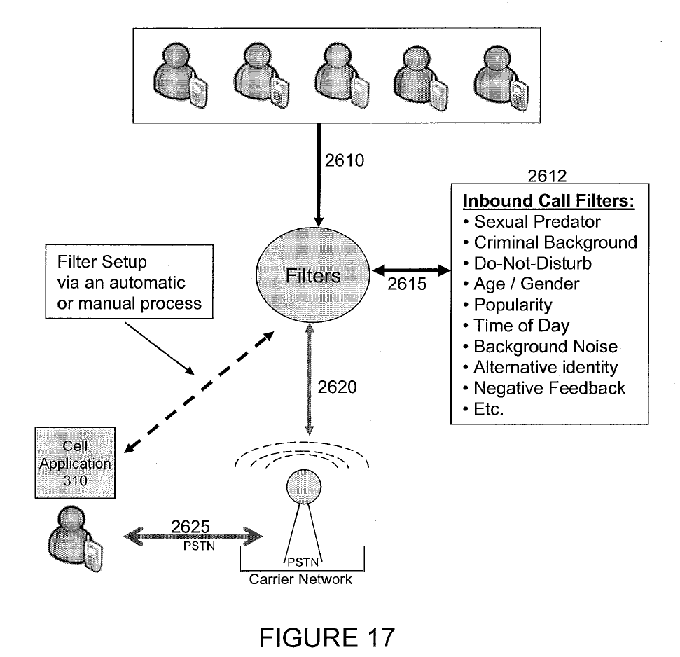

FIG. 17 is a schematic diagram that illustrates the implementation of filters for inbound calls. Outbound call filters can be implemented in a similar manner. At operation 2610 an inbound call is initiated from one or more callers. The inbound call is accepted by the alias service provider (as described above) and a filter database 2612 is accessed at operation 2615. As mentioned, the filters can vary and can include, for example, filters relating to sexual predator information, criminal background information, do-not-disturb information, age/gender information, popularity information, time of day information, background noise information, alternative identity information, and negative feedback information. The filters are used to provide features to the inbound calls as described in more detail below. The filters can be implemented based on various criteria, such as the address to which the call is directed, the address of where the call originated, etc. some of which are defined in the filters database. The filters can be set-up automatically by the alias service provider or in conjunction with user interaction, such as via the application 310. In operation 2620 and 2625, the inbound call is directed to the user.

Thus, a plurality of addresses, such as telephone numbers, are allocated or otherwise mapped to a single telecommunications device, such as a mobile telephone. The plurality of telephone numbers can include one or more numbers that are assigned to the telephone by a conventional mobile phone service provider, as well as additional numbers that are assigned by an alias service provider, as described below. The telephone can receive and/or make calls via any of the telephone numbers assigned to the telephone.

An exemplary use of the system is where a user wants to remain anonymous during a call or establish other controls to protect his or her privacy. The user can give one of the alias numbers to a limited number of people while giving the telephone's base number or another alias number to a different group of people. The user receives calls for all of the numbers on the same phone but can treat each call differently based on the number to which the call is made.

For example, a woman wishing to protect her privacy and safety while she pursues online dating relationships can give out an alias number that is reserved for new acquaintances. The woman may wish to stay anonymous during the beginning of dating communications, not revealing her name or other information that would personally identify her. Yet, she still wants to be able to speak with a potential partner while in anonymous mode. Thus, the woman gives new acquaintances a certain alias number, rather than the base number. When the woman receives a call via the “new acquaintance” number, she can either choose to accept it, ignore it, or to have the rule set automatically treat the inbound call in a predetermined manner.

If the woman no longer wants to be accessible to a particular acquaintance, she can have the rule set automatically prevent calls from that acquaintance's phone number from being connected to the alias number that she had given the acquaintance. The woman can also cancel the “new acquaintance” number altogether and have it removed as one of the numbers she had acquired from the alias service provider, thereby preventing all the new acquaintances to whom she had provided that number from contacting her further in any manner.

In another example, a professional, such as a lawyer, can have several alias numbers associated with a telephone. One of the alias numbers can be used for work-related calls such that the lawyer can define rules on how the work related calls are handled and can also know when a call is received that it is work-related. Assume that the lawyer wants a weekend away from work calls but wants the freedom to answer all other calls whether from alias or base numbers. In such a case, the lawyer can specify a rule set that causes all inbound calls to the “work related” alias number to automatically go into a voice mail or do not disturb mode.

Yet another example is where a user places a “for sale” advertisement in an online classified listings service or a local newspaper or on an online auction service, but does not want to give out her base number in the advertisement for security and privacy reasons. In such a case, the user can be assigned an alias number by the alias service provider, wherein the alias number is only in effect for the duration of the advertisement and is canceled after the item is sold. The user can list the alias number in the advertisement and can receive calls on the alias number on the same telephone as the user's base number. After the item is sold or the user otherwise cancels the advertisement and the alias number, the user will no longer be contactable by members of the public who had retained the alias number.

Exemplary Scheme for Outbound Communications

FIG. 1C shows a schematic diagram that illustrates exemplary process for handling outbound communications from the telephone 110 to the telephone 115. As described, the alias service provider 180 has assigned the telephone 110 with one or more alias addresses, such as alias telephone numbers, that can be used to receive and send calls on the telephone 110. The subscriber can make outbound calls in connection with any of the alias numbers or with the base number. The alias service provider includes equipment and/or databases as described above with reference to FIG. 1B.

In an exemplary embodiment, the subscriber desires to initiate an outbound call on the telephone 110 to a target contact identifier, such as a telephone number. For purposes of this description, the telephone number to which the subscriber initiates the call is referred to as the “target telephone number” and the target telephone number points to the telephone 115 in FIG. 1C. The subscriber desires to have the call uniquely configured via the alias service provider.

In an initial operation, the subscriber launches the application 310 that resides on the telephone 110 wherein the application is configured to initiate a communication link with the alias service provider 180 in a predetermined manner. As described below, the subscriber can use the application 310 to define various parameters relating to how an outbound communication is to be handled by the alias service provider. Upon launch, the application 310 can optionally establish an initial administrative-related communication link with the alias service provider such as to perform initial administrative tasks. Such tasks can include, for example, downloading software updates, verifying the identity of the subscriber, attending to billing tasks, etc. The initial communication link can occur in various manners, such as via a telephone network or via a Internet connection. While the administrative communication link is being established, the subscriber can be interacting with the application 310 to define the outbound call configuration, as described in detail below.

In a next operation, the subscriber instructs the application to initiate an outbound communication to a target address, such as an outbound telephone call to a target telephone number. This can occur, for example, by pressing a send key on the telephone or taking some other action. The application establishes a communication link 330 with the alias service provider 180. The communication link 330 can be implemented in any manner, such as through a PSTN or via the Internet. At least one purpose of the communication link 330 is for the application to provide the alias service provider 180 with information regarding the target telephone number and how the user desires to configure the outbound call.

It should be appreciated that a communication link between the telephone 110 and the telephone 115 has not yet been established. Prior to establishing such a link, the alias service provider 180 takes various actions to configure the call.

In the next operation, the call controller 202, consults the various databases 206, 207, 208 using information provided by the application 310, such as configuration information specified by the subscriber. The call controller obtains a temporary address, such as a temporary telephone number, that points to the alias service provider 180 and that will be provided to the telephone 110 for establishing a subsequent communication link 335 with the media controller 204. The call controller 202 then transmits (via the communication link 332) the temporary telephone number to the application 310 on the telephone 110.

In the next operation, the application provides the temporary telephone number to a dialer application on the telephone 110. Using the temporary telephone number, the dialer application then establishes a communication 335 with the alias service provider 180 such as by placing a call over a PSTN 218. In an alternate embodiment, the initial step of the application connecting to the alias service provider 180 via the communication link 330 is eliminated. The subscriber can simply place a telephone call to the alias service provider 180 over the PSTN 218 or in some other manner.

The media controller 202 can then perform certain actions relating to the outgoing communication, such as by implementing filters contained in user-defined profiles. For example, the media controller can set a predefined user identity, such as caller ID, for the call or can automatically set up recording of the call (subject to legal requirements for recording calls.)

At this stage of the process, there is still no communication link between the telephone 110 and the telephone 115. The media controller 204 then establishes a communication link 340 over a PSTN 212 (or other form of communications link) to the telephone 115 using the target telephone number. A communication link 340 now exists between the alias service provider 180 and the telephone 115. A communication link 335 also exists between the telephone 110 and the alias service provider 180. The alias service provider 180 then establishes a two-way communication link between the telephones 110 and 115 with the alias service provider 180 having at least some control over the communication link. If desired, the media controller can update a call details records database, such as for billing purposes.

The alias service provider can establish the communication link 335 in various manners and protocols. Advantageously, the communication link can be established pursuant to a protocol or network that differs from the protocol or network of the link 335. For example, the link 335 can be pursuant to any type of service or protocol, such as Skype, Vonage™, AIX, PBX) while the call originated from a different protocol.

In addition, the subscriber can set up one or more profiles that specify how outbound calls with be connected on the termination link 335. The profiles can be associated with specific number or groups of numbers to use a specific termination service or protocol based on a predetermined rule. In this regard, the subscriber can set up a database of passcodes (such as username/passwords) that can be readily accessed by the alias service provider when the alias service needs a passcode to complete the link 335.

FIG. 3C shows an exemplary configuration of an outbound filters database. The outbound filters database includes data related to how the subscriber desires the alias service provider to handle outbound calls. As mentioned, the subscriber can specify rules on a number-by-number basis or rules based on groups of numbers, wherein the rules specify how an outbound call for that number is handled. The filters database can include various data related to outbound call handling, such as call recording (subject to legal requirements for recording calls), conference call features, distortion of voice, piping in of background noise, caller ID, etc.

FIG. 1D shows several flow charts that describe alternate methods for initiating outbound communications via the alias service provider. A first method is Tone Dialing method. In an initial operation 360, the subscriber decides to initiate an outbound call. The method can proceed in either of two ways. In operation 362 the subscriber selects a dial-in number to the alias service provider from a list of dial in numbers on the telephone directory of the telephone. Alternately, in operation 364, a geographically-closest dial in number is automatically selected using GPS. In the next operation 366, the telephone dials into the alias service provider using the log-in number. In operation 368, 369, and 370, the subscriber provides instructions to the alias service provider either manually or through an automated process. Using tones, the outbound call is passed through to the target number and the user is connected to the target number using specified parameters.

Another method is a URL call back method, which was described above with reference to FIG. 1C. Another method is the alternative number method. After the subscriber decided to initiate an outbound call at operation 360, the telephone sends call set-up information to the alias service provider via a uniform resource locator (URL) at operation 372. At operations 374 and 376, the server selects an available phone number from a database and then conditions the outbound call with parameters defined by the user. At operation 378, the alias server provides the telephone 110 with a temporary number and the telephone dials the temporary number at operation 380. The user is then connected to the target number using the specified parameters at operation 382.

With reference to FIG. 1E, there is shown a carrier or in-network method. Pursuant to this method, the outbound call is made through the SPN of the telephone. In a first operation, 360, the user decides to make an outbound call. In operation 364, the telephone sends call-setup information and the target number to the a server or switch operated by the SPN. In operation 386, the server or switch passes the outbound call through with the desired configuration parameters. The user is then connected to the target number using the specified parameters at operation 388.

FIG. 1F shows a flow diagram that describes an exemplary process for initiating outbound calls from the telephone. As shown in operation 390, the user can initiate the outbound telephone call by either entering an alphanumeric string of digits on the keypad or by selecting a telephone number from an address book on the telephone. Pursuant to one procedure A, the telephone number to be accessed is, for example, 212-555-4455. That number is entered into a User Interface (UI) 398.

In a next operation 392, the telephone checks to see if the outbound number is in a database and is associated with a profile that has predetermined features associated with that caller profile. The check can be performed locally at the telephone or can also be performed by the alias service provider. For example, the profile can specify that any outbound calls for any number associated with the profile are provided with a predetermined identification (such as caller ID). Thus, in operation 393, a check is performed to determine whether the telephone number has a Group profile ID and, if so, the outbound identification (such as caller ID) is set at operation 296. Alternately, in operation 394, the telephone number is not in the database then the user can manually assign an identification to the call. It should be appreciated that the user can override parameters that are defined in profiles related to alias numbers. The UI 398 identifies the caller ID that will be used for the outbound call.

In another operation 397, the user can specify the telephone number where the outbound call will originate from. In other words, the user can make an outbound call from a telephone 110, but the alias service provider will configure the outbound communication such that it appears that the call originated from a number of the user's choosing.

The user can also configure a profile such that the alias service provider automatically sets the caller ID for an outbound call to a predetermined number based on the outbound number being called. For example, the subscriber could set up a profile such that whenever the subscriber calls number X, the caller ID is set to number Y regardless of which number the subscriber is actually calling from. This could prevent a subscriber from calling someone and the caller-ID showing a work-related alias number when the subscriber only intended to show a dating related alias number on caller ID.

Various Communication Configurations

As discussed above, the alias service provider can control inbound and outbound communications for the telephone 110 and provide features to the communications that are not governed by limitations of the SPN. Described below are various features that can be implemented for the communications. For sake of example, the features are sometimes described in the context of the communications being telephone calls between telephones. It should be appreciated, however, that the described features can be modified for use with other types of communications between non-telephone addresses.

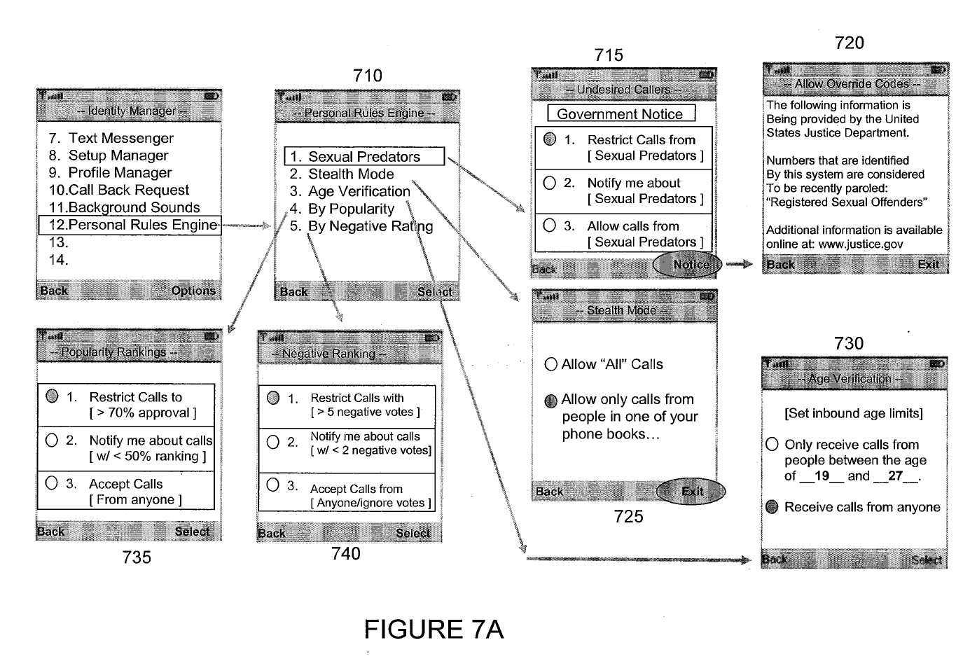

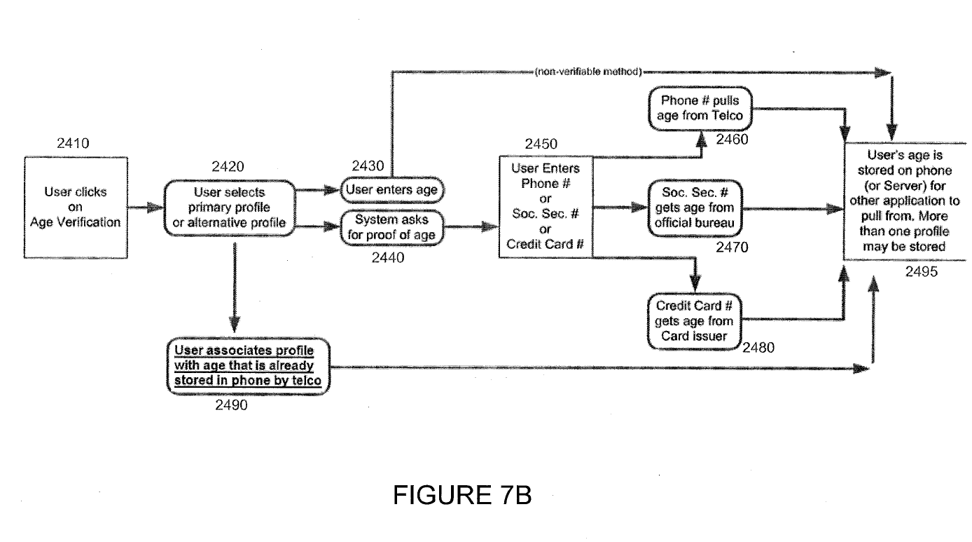

In one embodiment, the subscriber can configure one or more rules that govern how the alias service provider provides such features. The rules can be contained in a Rules Engine that resides in the local application 310 or in the filters databases at the alias service provider. FIG. 7 shows an exemplary series of user interfaces that define the Rules Engine. The rules engine allows the subscriber (or other authority) to preset certain rules that govern use of the alias service. An exemplary basic list of functions is as follows. A Personal Rules Engine interface 710 can be used to access management pages for governing the Rules Engine.

User Identification for Outbound Communications

FIG. 1G shows another exemplary embodiment of a telecommunications network 100 that can effectuate various communication-related features in accordance with the present disclosure. The telecommunications network 100 is illustrated in a different manner than in FIG. 1A, although the features described with respect to FIGS. 1A and 1B can be implemented in either embodiment. FIG. 1G is used to describe exemplary features that can be implemented with respect to outbound telephone calls from the telephone 110.

The telecommunications network 100 can include components that are typically associated with a public switched telephony network (PSTN), as well as components associated with a wireless telephony network, such as a cellular telephony network. The telecommunications network 100 can also be configured to include components of an Internet Protocol (IP) network to effectuate corresponding functionality and services, such as, for example, voice over IP (VoIP).

As shown in FIG. 1G, the telecommunications network 100 can be used to effectuate a voice trunk 105 between a calling party having a first telecommunications device, such as a telephone 110, and a calling party having a second telecommunications device, such as a telephone 115. The telecommunications network 100 can also effectuate conference calling wherein voice trunks are established between more than two telecommunications devices.

The telecommunications devices are described herein in the context of being telephones (which includes wireless telephones and Voice over IP phones (e.g., web phones) and hybrid wireless/VoIP phones), although it should be appreciated that the telecommunications devices can be any type of device through which voice and/or data communications can be implemented. The telecommunications network 100 further includes one or more Service Provider Networks (SPNs) 120, 125 that provide local telephone service to the telephones 110 and 115. As mentioned, an SPN may be a LEC, (Local Exchange Carrier), a CLEC (Competitive Local Exchange Carrier), a wireless telephony carrier, a VoIP provider, or any other network which provides endpoint-to-endpoint communications between subscribers. The SPNs 120 and 125 can be interconnected via one or more interexchange carriers (IXCs) in a well-known manner, though it is possible that an SPN does not use any IXC or other resource to complete end-to-end calls.

The telecommunications network 100 includes a master database 130, such as a Calling Name Database (CNAM), that includes profile data relating to subscribers of the SPNs' services. Although FIG. 1G shows only a single master database, it should be appreciated that the network 100 can include more than one master database. The profile data can be accessed by the SPNs 120, 125 and provided to a called party pursuant to a caller ID system. In this regard, the master database 130 can include, for example, a name or other indicia associated with each subscriber. For each subscriber, there is also one or more station IDs, such as a telephone number (e.g., a ten-digit number which comprises a three-digit area code defining a specific geographic area followed by a three-digit office code identifying a particular SPN switch, that is followed in turn by a four-digit customer line). For example, Table 1, below, shows exemplary fields that are associated with each subscriber in the master database 130. It should be appreciated that the master database 130 can include additional information or information other than that shown in Table 1. Thus, Table 1 is merely an example and does not limit the configuration of the master database 130.

TABLE 1

| Telephone Number | Subscriber Indicia |
|---|---|
| 888-555-1111 | John Doe |
| . . . | . . . |
| 777-555-1212 | ACME Products |

The master database 130 is maintained by a master administrator that has both reading and writing authority to the contents of the master database 130. The administrators of the SPNs 120, 125 have the ability to read data from the master database 130, but can only write data to the master database 130 in certain circumstances, as described more fully below.

With reference still to FIG. 1G, each SPN maintains a local subscriber database, such as a local database 135 for the SPN 120 and a local database 140 for the SPN 125. At least some of the data fields in the local databases correspond to the data fields in the master database 130. In this regard, the local databases contain data, such as subscriber indicia and telephone numbers, for the respective subscribers of the SPNs. Thus, each SPN has sole authority for maintaining the data contained in its respective local database. The master database 130 includes a compilation of all of the data contained within the collective local databases or simply a compilation of all data associated with a particular phone numbers issued by a specific SPN 120. In some cases, a SPN 120 may only maintain one database to resolve phone numbers against as in a traditional CNAM (or related) lookup. In the case where only one database is maintained, the SPN's 120 Database 135 and the Master Database 130 would simply be one single database (either 135 or 130) to the rest of the telephony network. It is also understood that each SPN 120 and 125 may maintain a single Database 135 or 140 as its official Master Database 130 (or CNAM database). So, the Master Database 130 and the SPN 120, 125 Databases 135, 140 may be completely interchangeable in the figures contained herein.

As mentioned, the SPNs can provide data to the master database 130 pursuant to limited circumstances. For example, the master database 130 can periodically perform a synchronization process wherein the master database 130 queries the local databases for an upload of data from the local databases, which upload can include the entire local database or only modified data. Such a synchronization can occur on a regular basis, such as regularly on passage of a predetermined time span. Another way that the data can be synchronized is by the SPNs sending a prompt to the master database 130 upon any data being modified or updated in the respective local database. Upon receiving such a prompt, the master database 130 performs a data synchronization. Another way that the data can be synchronized is by the SPN pushing modifications (such as Adds, Deletes, and /Changes) to synchronize its database 135 or 140 with the master database 130.

A typical caller ID process works as follows. First, a calling party (who is a subscriber of SPN 120) at the telephone 110 initiates a call to called party (who is a subscriber of SPN 125) at the telephone 115. The telephone 110 establishes a connection with SPN 120, which establishes a connection with SPN 125. As mentioned, the connection between the SPNs can occur via an interexchange carriers (i.e., a long distance provider).

Assuming that the called party subscribes to a caller ID service, and the calling party is not blocking or restricting his phone number from being displayed, the SPN 125 queries the master database 130 for relevant information (such as subscriber indicia (e.g., subscriber name) and/or telephone number associated with the telephone number of the calling party, which information is contained in the master database 130. As mentioned, the master database 130 contains such information pursuant to the synchronization process that occurs between the local database 135 of the SPN 120 and the master database 130. The SPN 125 of the called party then obtains the relevant information of the calling party from the master database 130 and provides such information to the called party's telephone 115 for display. For example, the telephone 115 can display the calling party's name and telephone number, which the SPN 125 obtained from the master database 130. In this manner, the called party has been provided with the calling party's relevant information pursuant to a caller ID service.

It should be appreciated that the local databases are maintained by their respective SPNs, which generally comprise business entities such as corporations. An individual user (i.e., a subscriber) to the SPN does not have authority or the ability to arbitrarily modify the data contained in the SPN. If a subscriber desired to change its information contained in the local database of the SPN, the subscriber would have to contact the SPN and request that the information be changed. The subscriber then has to wait for the SPN to implement the requested changes. Thus, it can be appreciated that subscribers can be generally reluctant to modify their caller ID data given the potential tedium associated with such a process. Lastly, it is up to the SPN 120, or the party that controls the local phone number database 135 or 140, to approve any such requested change. In general, SPNs (120, 125) and service providers prefer to use a subscriber's billing information to complete fields found within the local database 135, which in turn is replicated in the master database 130 later.

There is now described systems and methods for providing caller ID services that are much more user-friendly for subscribers of SPNs. With reference still to FIG. 1G, the telecommunications network 100 includes a private database 145 that can be accessed by subscribers without having to go through a SPN. The private database 145 includes data associated with one or more blocks of telephone numbers, wherein the telephone numbers have been previously purchased or otherwise acquired from one or more SPNs. For example, the telephone numbers associated with the private database 145 can include several hundred telephone numbers acquired from the SPN 120 and several hundred or thousand telephone numbers acquired from the SPN 125. Lastly, the telephone number associated with the private database 145 can include numbers that a subscriber already has control over (or access to or permission to use) like his home, cell or work phone number. For each telephone number in the private database, there is an associated primary indicia such as the primary indicia described above with reference to table 1. The primary indicia is the indicia that is displayed as a default in connection with caller ID when a subscriber associated with the telephone number makes a telephone call. Each telephone number can also have additional data associated therewith, as described further below.

In one embodiment, each telephone number in the private database 145 also has one or more alternate indicia associated therewith. The alternate indicia comprise subscriber-specified indicia that can alternately be displayed in connection with caller ID, or that can be displayed in addition to the primary indicia. In other words, the alternate indicia comprise various “aliases” that can be associated with a telephone number in the private database. Table 2, below, shows an exemplary embodiment of a private database having fields for telephone numbers, primary indicia, alternate indicia, and “other” data fields, which are described more fully below.

TABLE 2

| | | | | |
|---|---|---|---|---|
| Telephone | Primary | Alternate | Alternate | |
| Number | Indicia | Indicia 1 | Indicia 2 | Other |

| | | | | |
|---|---|---|---|---|
| 1 | 888-555-1111 | John Doe | Jane Doe | ACME |
| | | | | Products |
| 2 | 888-555-6161 | Jim Wilson | John Smith | Dad |
| 3 | 888-555-3434 | Jane Smith | Jane Wilson | Mom |

In the example of the private database shown in Table 2, the telephone number “888-555-1111” has a primary indicia of “John Doe”, a first alternate indicia of “Jane Doe”, and a second alternate indicia of “ACME Products”. It should be appreciated that although Table 2 shows the private database as having two alternate indicia, that the quantity of alternate indicia uses (if any) can vary.

The private database 145 of the telecommunications system is set up as follows. First, an entity, such as an individual or a business entity, acquires the rights to one or more telephone numbers from telephone service providers such as local exchange carriers or other SPNs. All of the acquired telephone numbers are assigned an entry in the private database 145. The telephone numbers are then assigned, such as for a fee, to subscribers of a service that maintains the private database 145. Henceforth, the subscribers can use the telephone numbers to make and receive telephone calls on the telecommunications network.

The subscribers to the private database service can populate the fields of the private database as the subscriber sees fit. Thus, the subscriber can specify the contents of the primary indicia and the contents of the alternate indicia and can vary such contents at will. As described more fully below, the subscriber can edit the contents of the private database in a variety of manners, such as by accessing the private directory through the Internet or using a special application that has been loaded into his phone. Accordingly, the subscriber does not have to obtain permission of any SPN to view or edit the contents of the private database.

The private database 145 is configured to synchronize, either directly or indirectly, with the master database 130. The purpose of the synchronization between the private database 145 and the master database 130 is to provide the master database with the most recent telephone numbers and corresponding primary indicia from the private database 145. In this manner, when a subscriber makes a call associated with one of the telephone numbers, the corresponding caller ID indicia is the primary indicia of the private database. It should be appreciated that the private database 145 can be organized in a variety of manners, and that the organization shown in Table 1 is merely exemplary. For example, the Phone Number and the Primary Indicia may be set to different fields (such as fields 1 and 2) of the database.

As mentioned, the synchronization between the private database and the master database can occur in either a direct or indirect manner. A direct synchronization can occur in the same manner that the SPN local databases synchronize with the master database 130, such as was described above. That is, the private database 145 communicates directly with the master database 130, as represented by the synch line 147 connecting the private database 145 and the master database 130 in FIG. 1G. When the synchronization 147 occurs, the master database 130 is updated with the telephone number and primary indicia data from the private database 145.

Alternately, the synchronization between the private database and the master database can be indirect. In the indirect scenario, the private database 145 conducts a direct synchronization with one or more associated SPN local databases, such as with the local database 135, as represented by the synch line 150 in FIG. 1G. The private database 145 provides the local database with updated telephone number and the user-selected primary indicia data. Then, when the local database 135 synchronizes with the master database 130, the latest data from the private database is effectively updated into the master database 130. In any event, for either the direct or the indirect synchronization scenario, the master database is regularly updated with data from the private database 145.

In use, a subscriber to the private database makes a telephone call in connection with one of the telephone numbers that the subscriber has rightfully acquired access to via the private database. For such a telephone number, the corresponding primary indicia resides in the private database, the master database, and possibly in one or more of the local databases of the SPNs as a result of previous synchronizations. The telephone call is routed through the telecommunications system as described above. If the called party has a caller ID service, then the called party's SPN will query the master database 130 for the calling indicia for display on the called party's telephone equipment. As mentioned, the indicia in the master database 130 is the same as the primary indicia in the private database as of the most recent synchronization between the master and private databases.

In one embodiment, subscribers of the private database 135 can remotely access the private database 140, such as to view and/or modify the information connected with their telephone number(s). The subscribers can also amend the contents of the private database, as described more fully below. The private database 135 can be remotely accessed, for example, via a communications network such as the Internet or a special application that has been loaded within a telephone. With respect to amending the private database, an owner of a telephone number in the private database can change the contents of the primary indicia field, change a primary indicia to an alternate indicia, or change an alternate indicia to a primary indicia. Upon the next synchronization between the private database and the master database, the changes that the subscriber made will be reflected in the master database. In this manner, subscribers can update the identification indicia associated with their telephone numbers in a quick and easy manner. Thus, the subscriber effectively updates (i.e., modifies or adds to) the master database 130 (such as a CNAM database) by updating the private database.

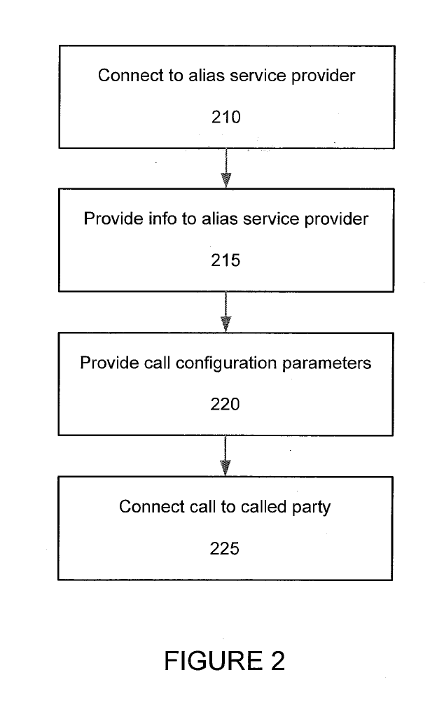

As discussed above, the private database can be managed by a service provider (referred to as the “alias service provider”) that resides at some location in the telecommunications network 100. There is now described a method of making a telephone call using the alias service provider. The method enables a subscriber of the alias service to dictate the information that is provided to a called party pursuant to a caller ID system. The method is described with reference to the flow diagram shown in FIG. 2. In a first operation, represented by the flow diagram box 210, a subscriber establishes a telecommunication (or network) connection with the alias service provider. The “subscriber” is an entity, such as an individual or a business entity, that has access to a telecommunication device, such as the telephone 110 shown in FIG. 1G.

As mentioned, the telephone 110 can be any type of telecommunication device. For example, in one embodiment, the telephone 110 is a conventional telephone that is connected to the SPN 120 in a conventional manner. In this case, the subscriber can connect to the alias service provider by dialing a telephone number associated with the alias service provider. Telecommunication equipment associated with and/or controlled by the alias service provider can reside, for example, at the SPN central office. Alternately, the alias service provider can reside at some other location in the network 100. In such a scenario, the subscriber can manually cause the telephone call to go through the alias service such as by dialing a special phone number associated with the alias service. In another embodiment, a dedicated telephone number, such as a 1010-220 type of number, is called to reach the alias service.

In another embodiment, the telephone 110 comprises a wireless telephone that operates, for example, pursuant to a cellular service or a personal communications service (PCS). In such a case, the telephone 110 can connect to the SPN and/or the alias service provider by first connecting to a base station and mobile switching station of the wireless phone service provider. The mobile phone service provider then hands control of the call over to the alias service provider. Alternately, the mobile service provider connects the call to an alias service system which the mobile service provider controls (e.g., is controlled by the mobile service provider or SPN, which provides service to the subscriber). In such a scenario, the mobile service provider implements and/or runs its own alias service. Thus, the mobile provider can build and manage its own alias service.

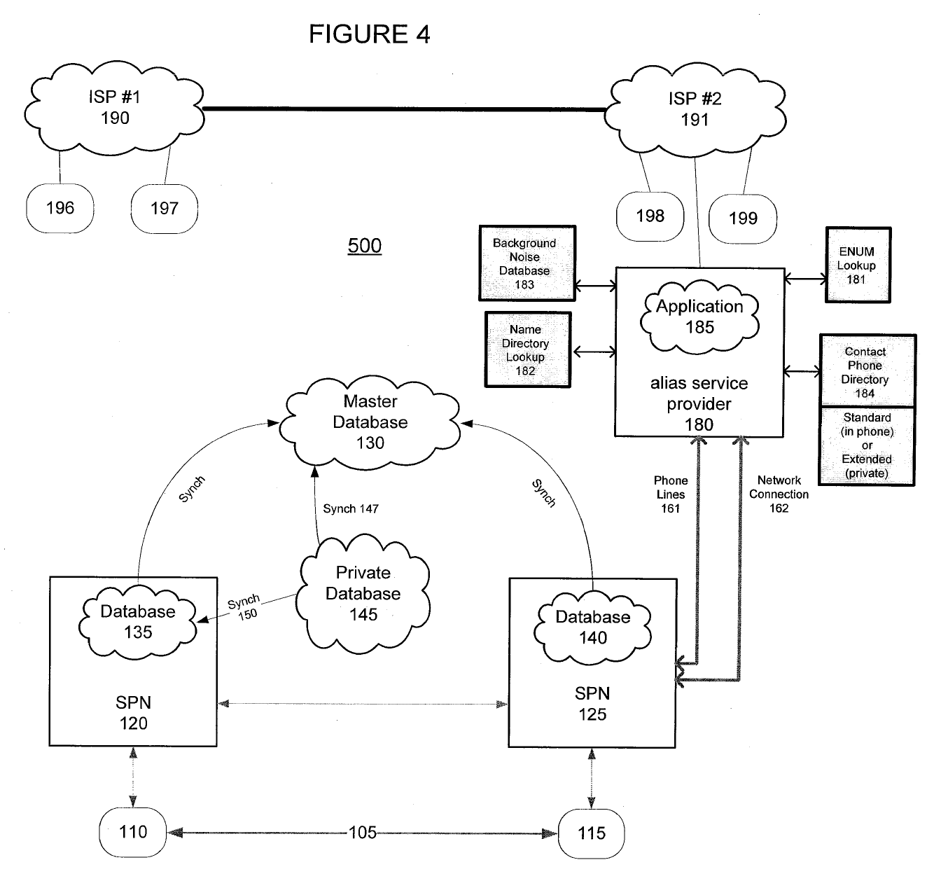

In one embodiment, the wireless telephone 110 is equipped with an application 310 that resides on the telephone 110, as shown in FIG. 3A. The application 310 can have access to a contact directory or database 315 (also known as a phone book) that also resides on the telephone 110. The contact directory 315 comprises a database (or list) of contacts and can include, for example, names, associated telephone numbers, address, etc., in a well-known manner. When the application 310 is executed, the application 310 causes subsequent telephone calls initiated from the telephone 110 to automatically go through the alias service provider (such as by automatically dialing a number associated with the alias service provider and then causing the alias service provider to initiate the telephone call). In another embodiment, shown in FIG. 4, the telephone 110 has access to a contact phone directly 184 that is remotely located at the alias service provider.

Advantageously, the application 310 interfaces with the contact directory 315 such that the subscriber can initiate calls from the contact directory by selecting an entry (or multiple entries) in the contact directory. The application 310 then automatically causes the telephone to connect to the alias service provider and provide any required information to the alias service provider without any further subscriber interaction. In this manner, the whole process is transparent to the subscriber and does not require any special actions by the subscriber other than to initially execute the application 310. The application 310 can also be used with other telecommunications devices, such as with a VoIP enabled telephone or a hybrid cellular/VoIP telephone.

In one embodiment, a backup version of the information in the contact directory 315 can reside on a computer network, such as the Internet. The telephone 110 can be used to access the contact directory 315 via the Internet, such as to view, add to, or revise the information contained in the contact directory 315. Alternately, the user can view and edit the data in the contact directory 315 via a Web browser on a separate device (such as a PC) rather than by coupling the phone to the Internet. This can sometimes be easier than adding to or revising the information using the telephone 110. In addition, the information contained in the backup version of the contact directory 315 can be downloaded to another phone (whether or not the other phone is compatible with the initial phone), such as if the subscriber has multiple phones, if the subscriber switches phones, or if the subscriber loses his phone and needs to restore the information to a new phone. Thus, the information contained in the contact directory 315 is contained in the phone itself and a backup is contained at some location on the Internet or some other data network. The backup system is described in more detail below.

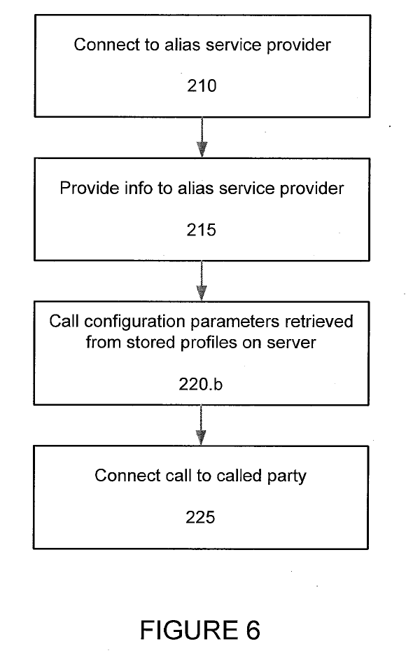

With reference again to the flow diagram of FIG. 2, after the subscriber connects to the alias service provider, the subscriber provides relevant information to the service provider, as represented by flow diagram box 215. In an alternative embodiment of the method, shown in FIG. 6, the relevant information in the form of call configuration parameters are accessed from a server that stores profiles at the alias service provider, as represented by flow diagram box 220b in FIG. 6.

If the subscriber manually provides the information, the subscriber provides the telephone number for the called party, which is the party that the subscriber is trying to call, such as, for example, the telephone 115 in FIG. 1G. In the scenario where the application 310 (FIG. 3A) is handling the call, the application 310 can be configured to automatically provide the called party's telephone number to the alias service provider. As mentioned, the application 310 can obtain the called party's telephone number from the contact directory 315 (FIG. 3A) on the telephone. Alternately, the subscriber can manually enter the called party's telephone number in response to prompts that are provided by the alias service provider.

The subscriber can select a phone number to dial via a standard (or extended) Contact Phone Directory 184 (FIG. 4) that resides at the alias service provider or via the service provider's Name Directory Lookup (NDL) 182 (FIG. 4) engine. The NDL may be a self registered (or opt-in) database of names and phone numbers or a more traditional yellow page engine, while the extended Contact Phone Directory 184 may contain phone numbers the user chooses not to enter into his phone but that reside at the alias service provider. This would allow a subscriber to have access to a private contact phone database 184 (FIG. 4) that would not appear within his standard contact phone directory 315 (FIG. 3A). The subscriber (or the application 310) can also provide a password, login ID, an EIN or any other such information that the alias service provider uses to verify that the subscriber is authorized to make calls through the service provider.

The application itself 315 may require the subscriber to provide a user login and/or password to initiate the program itself. Additionally, specific phone numbers, contacts or dialing rules may require re-confirmation of a pass code or a different pass code chosen by the subscriber.

In another embodiment, the subscriber may select a group code to initiate a phone call, wherein more than one telephone number is associated with the group code. When the subscriber initiates a call pursuant to a group code, all numbers found within the selected group code would be called together. This would allow a subscriber to select everyone on a conference call list with a single selection without the subscriber being required to select each and every individual potential conference participant from his contact list found within his phone. These group codes would be located with the subscribers dialing profile or within his/her standard/extended Contact Phone Directory 184 (FIG. 4).

In the next operation, represented by the flow diagram box 220 in FIG. 2, the subscriber provides one or more call configuration parameters to the alias service provider. The configuration parameters define the configuration of the outbound call. One such configuration parameter comprises the outbound telephone number that will be used as the subscriber's telephone number for the call. The subscriber can select any of the telephone numbers that the subscriber owns (or has access to) on the private database 145. For example, with reference to Table 2 above, the subscriber may own telephone numbers 1 and 2 in the database. For purposes of the instant call, the subscriber may select telephone number 1 (888-555-1111) as the phone number that is used as the originating number in the instant call. As described further below, when the called party receives the call, telephone number 1 will be displayed as the caller ID number and the primary indicia (888-555-1111) for telephone number 1 will also be displayed.

Another such configuration parameter relates to parameters that can be used to vary the configuration of the phone call to make it appear as if the phone call is originating from a different location or environment than the actual location or environment of origination. For example, one such parameter comprises background or environmental noise that is piped into the call, as described below.

In addition to the above, the application provides a PIM (personal information manager) functionality that is managed via user. When a user receives a call on a standard cell phone (non-PIM), a user interface screen is shown that provides pre-stored information about the calling party or the person being called. This feature works both ways. This feature provides limited PIM functionality to non-PIM-based phones.

Another configuration parameter can be whether or not caller ID is enabled for this particular call. The configuration parameter can specify that caller ID is enabled or that caller ID is blocked for this call. The configuration parameter can permit a subscriber to flag pre-selected telephone numbers (such as frequently called numbers) to have a default “unblocked” status and other numbers to have a default “blocked” status unless specified otherwise by the subscriber. Such a selective caller ID system would ensure proper dialing parameters for subscribers without the having to manually select “call block (*69) or unblock (*82)” on a call-by-call basis. Selective caller ID would allow a subscriber to flag certain frequently called phone numbers, like his home or office.

The private database can include default values for each of the configuration parameters, which default values are contained in the “other” fields of the private database. In this manner, each telephone number in the private database (or the Extended Contact Phone Directory 184) can have a predetermined, default alias configuration that is used for outbound (or inbound) calls associated with those numbers.

As mentioned, the subscriber can add to or edit the information in the private directory that is associated with telephone numbers owned by the subscriber. The subscriber can change any of the indicia, such as to rename the primary indicia or the alternate indicia. The subscriber can also change one of the alternate indicia to be the primary indicia. For example, in Table 2 the subscriber can change the primary indicia to read “Acme Products” rather than “John Doe”.

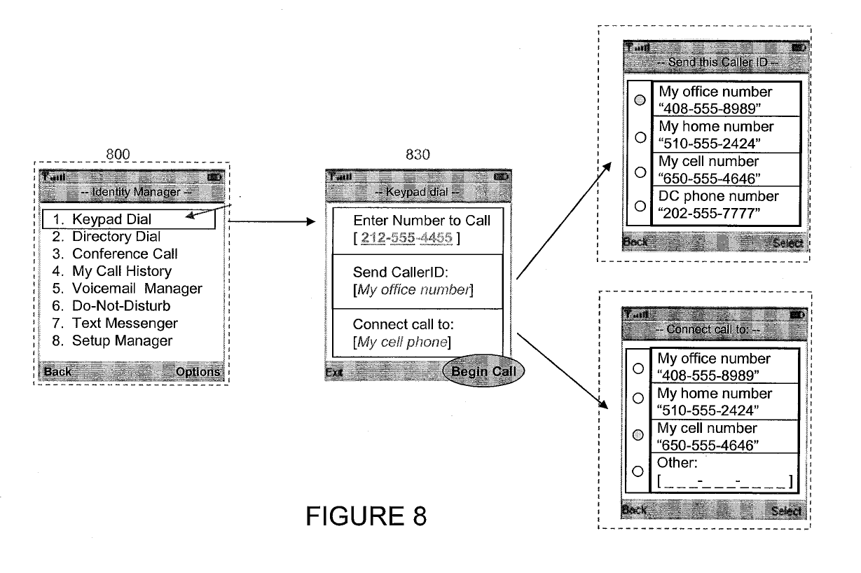

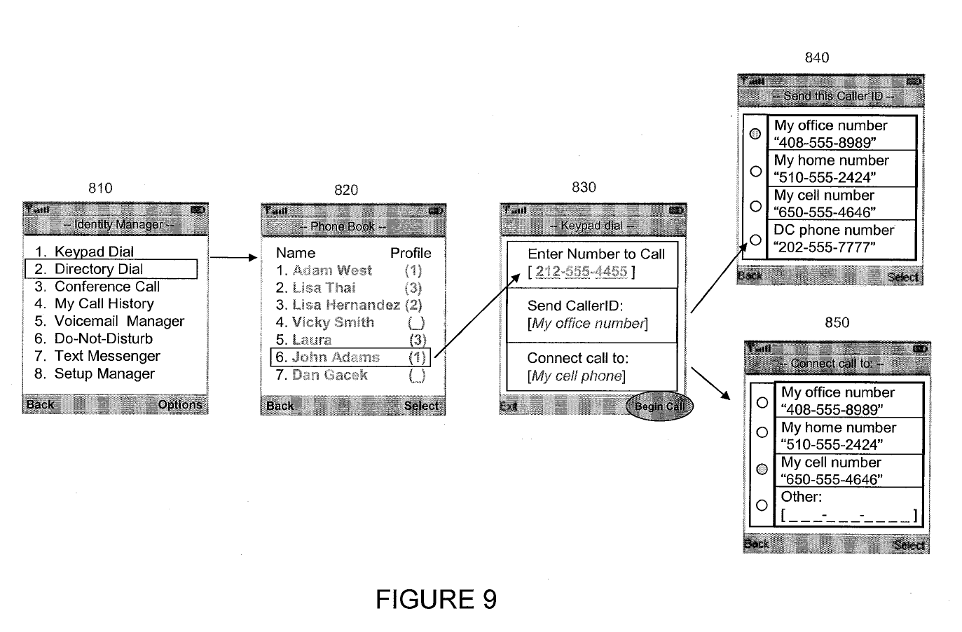

FIGS. 8 and 9 show a series of exemplary user interfaces that the application 310 causes to be shown on a display screen of the phone to effectuate the user provided configuration information. The user interfaces shown in FIGS. 8 and 9 can also be used to provider configuration information pursuant to the process described in FIGS. 1B and 1C. A first user interface 810 includes a menu with a plurality of user-selectable features that correspond to features described herein. Selection of a menu item, such as item 2 “Directory Dial” can lead directly to a user interface 830 that displays configuration options. Alternately, a user interface 820 (FIG. 9) can be displayed, which includes, for example, a list of phone book entries that can be dialed.

The use can select a phone book entry (such as entry number 6 “John Adams” in FIG. 9) wherein the entry is associated with a particular profile. Selection of an entry can automatically change the outbound caller ID based on the number being dialed and the profile associated with that number. For example, if the number being dialed is marked as a business contact vs. a personal contact in the user's local or network database, then the outbound caller ID can be changed to a specified number. Under some circumstances, a user may flag an outgoing caller ID as “no-override” which would prevent a user from accidentally changing his outbound caller ID from his “dating number” to his “work number”. This would prevent a users from making a serious mistake with dialing an individual.

The user interface enables a user to initiate a call from a first phone, such as a cell phone, and instruct the alias service to begin the call on a device other than that cell phone. This is useful for areas where there is poor cell phone coverage or when a user wishes to use a speaker phone. The user interface 410 permits the user to set up the configurations for the call, such as the number to call, the caller ID parameter(s) that should be sent (user interface 830) and the device that will initiate the call (user interface 850).

An authentication system which controls name/number pairs in user interface 820 verifies that a user has physical control of a number before it is added as an acceptable outbound calling ID. The user interfaces shown in FIGS. 8 and 9 and in the other figures herein are just examples of what a user interface could look like and it should be appreciated that the user interface can vary.

With reference again to FIG. 2, in the next operation, the alias service provider establishes a connection with the SPN (such as the SPN 120 in FIG. 1G), which then establishes a connection with the called party's SPN. As discussed above, if the called party uses (or subscribes to) caller ID services, the called party's SPN will connect to the master database 130 to obtain caller ID information associated with the telephone number of the calling party. Such caller ID information is the same information contained in the private database 140 as specified by the user as of the last synchronization between the private database 140 and the master database 130. Specifically, the SPN will access the telephone number previously specified by the subscriber during initiation of the call and the primary indicia associated with that telephone number. Advantageously, the subscriber can easily update or change the primary indicia, or select an alternate indicia, by accessing the private database, such as through the Internet.

In a scenario where a SPN 120 allows Caller ID information to be passed on during the calling process and the receiving SPN 140 accepts the Caller ID information without requesting a phone number lookup (or ENUM lookup), then the Master Database lookup process in FIG. 1G would be replaced with a simple Send (e.g., Number and Name) from sending SPN 120 to a simple Receive (e.g., Number and Name) at the terminating SPN 125

Blocking or Filtering of Inbound Communication

A sexual predator or criminal notification feature allows a person to determine (in an automated process) if a person they are calling is a listed sexual offender or if the called person has a criminal record. In addition, the reverse can also be implemented . . . when the alias service provider recognizes that a listed sexual offender or person with a criminal record tries to call one of the virtual numbers, the called party is notified that the call they are about to receive is from a registered sexual offender or someone with a criminal record. FIG. 7 shows exemplary Sexual Predator interfaces 715 and 720 that can be displayed on the telephone 110 for defining the sexual predator features.

A stealth mode feature is designed for people that want to protect young kids or persons under care from receiving calls from unknown people. This feature blocks calls from a calling party that is not found within the user's current phone book 315 (or online CDF 184). This feature can also be used to block outbound calls to individual numbers that are not listed within the user's phone book(s). FIG. 7A shows an exemplary Stealth Mode interface 725.

An age or gender verification system allows a user to accept or deny calls based on age and/or gender as defined by an age and/or gender parameter. The age parameter may exist in the cell phone (FIG. 3A) itself or on the network (FIG. 4). The feature allows a user to restrict calls to someone: over, under, or exactly a certain age. This can be utilized by people in the dating world to verify the actual age of a caller or someone they are calling. FIG. 7A shows an exemplary Age Verification interface 730 that governs how the alias service manages such a feature.

When a call is received from someone outside of the calling parameters, the user has the ability to setup an automatic action. This action can be a pre-recorded message, an automatic hang-up, an automatic busy tone or some other action (such as the blocking actions defined above) that would deter the caller from calling again.

The age verification can be set within the phone by a carrier (or an unverified age parameter can be set by the user). If an unverified age is set, the other party can be notified. In addition, the age parameter can be set though a credit card or a social security lookup process. Other forms of guaranteed age verification may also be substituted. This feature can be used in conjunction with other rules, if desired.

In one embodiment, the alias service provider provides a system for age verification of its subscribers. As mentioned, the subscriber can set up profiles that are associated with a single alias number or a group of alias numbers. The profiles can be associated with predefined or manually defined rules that govern how inbound and outbound communications are handled with respect to the alias numbers. Age-related features can be associated with a profile.

FIG. 7B shows an exemplary flow diagram relating to age verification features of the alias service provider. In a first operation 2410, the subscriber (user) selects accesses an age verification user interface, which can be graphical or audio. In operation 2420, the user selects whether to access a primary profile or an alternate profile. Pursuant to a first alternative operation 2490, the user associates the profile with an age that has already been stored in the telephone by an SPN associated with the telephone. In operation 2495, the user's age is stored on the telephone or on a server. The age is then readily accessible by the alias service provider such that the alias service provider can filter communications based on the age.

In another alternative operation 2430, the user manually enters his or her age. The method then proceeds to operation 2495 as described above. In yet another alternative operation 2440, the alias service provider asks for proof of the user's age. The inquiry as to proof can come from the application itself or it can be prompted from a server at the alias service provider. In operation 2450, the user provides some type of proof as to age. The proof can vary, but can include, for example, a phone number that is tied with age, a social security number, a credit card number, etc. Based on the proof provided, the alias service provider can verify the age, such as by pulling the age from a telco associated with a telephone number provided (operation 2460), an official bureau such as Social Security (operation 2470), or from a credit card issuer (operation 2480). The method then proceeds to the operation 2495 as described above.

A popularity feature allows a user to set certain restrictions on who is allowed to call (or who they want to call) based on a popularity score. FIG. 7A shows a Popularity Ranking interface 735. In one embodiment, persons that are not subscriber's can provide information to the alias service provider relating to an individual whether or not that individual is a subscriber. Such information can be stored by the alias service provider and used in filtering of inbound and outbound calls.

A negative feedback allows a user to set certain restrictions on who is allowed to call (or who they want to call) based on a negative feedback from others. In other words, if enough people identity a person as negative, their score will reflect it. An exemplary Negative Ranking interface 1640. Similarly, a “married status” parameter may be set by individuals by simply entering the person's phone number(s) into an application or Alias Service Provider. This method of automated feedback from users would allow an Alias Service Provider to collect lots of information on users that are NOT associated with its' service and without necessarily collecting name or address information on the end user.

Backup Database Service

As described above, a backup version of the contact directory (FIG. 3A) can be stored on a data network such as on the Alias Service Provider via the Internet. The user can copy all the data in the contact database 315 within a particular phone to a backup database on a data network such as the internet. This allows a user to replicate his or her contact information on another phone.

In one embodiment, the backup database is configured to understand the parameter differences between different models of phones. Some phones permit a database to have a predetermined quantity of parameters for each entry, wherein the parameters are not necessarily uniform between different phone models. For example, some phones only allow one Home, Work and Cell number, while other phones allow multiple Home, Work, and Cell numbers. In addition, some phones allow fax number, email addresses and web site address for each phone contact name. The backup database is configured to map the differences between different phone models—thus allowing a user to upgrade or even downgrade data between feature rich cell phones. The user can connect his or her phone to the backup database and download data as required from the backup directory.

Because the data is stored on a data network such as the Internet, a user can recover from a damaged phone within minutes of getting his/her new phone without worries about phone handset differences or service providers. This process otherwise could have taken hours to rekey the old phone addresses or prevented a handset model change by the subscriber.

Extended Contact Phone Directories (CPD)

The contact phone directory (CPD) 184 can reside at some location on a network, such as at the alias service provider 180. This permits the contact phone directory to store an amount of data that is not limited by the hardware of the subscriber's phone.

Conventional phone handsets typically come with limitations on the amount of phone names/numbers each handset can store. Because the data is stored locally on the phone, the privacy of each name/number contained within the phone can be compromised if physically accessed by the wrong person. The extended CPD 184 allows a user to maintain a private or extended phone directory on the Internet that is not visible or accessible to anyone but the subscriber. Moreover, because the contact items are stored remotely relative to the phone, the subscriber will not have any limitations on the amount of numbers that can be stored. The alias service provider 180 can also require that a subscriber provide security authentication in order to access the CPD 184. Because the database is remote and requires authentication prior to access, the contact information is more secure than if stored locally as in a traditional phone 110,

Conference Calling

As mentioned, the alias service provider can also be configured to implement an automatic conference call service. Pursuant to this aspect, a subscriber can choose multiple addresses (such as phone numbers, SIP URIs or any other type of address) within his/her contact address list contained on telephone or other endpoint client device or software. When the user hits an execute command (e.g., dial), the application 310 or 185 automatically calls all chosen numbers at once and dumps the resultant calls into a conference room. In addition, a user may also be able to type in other numbers to be added to the conference call.

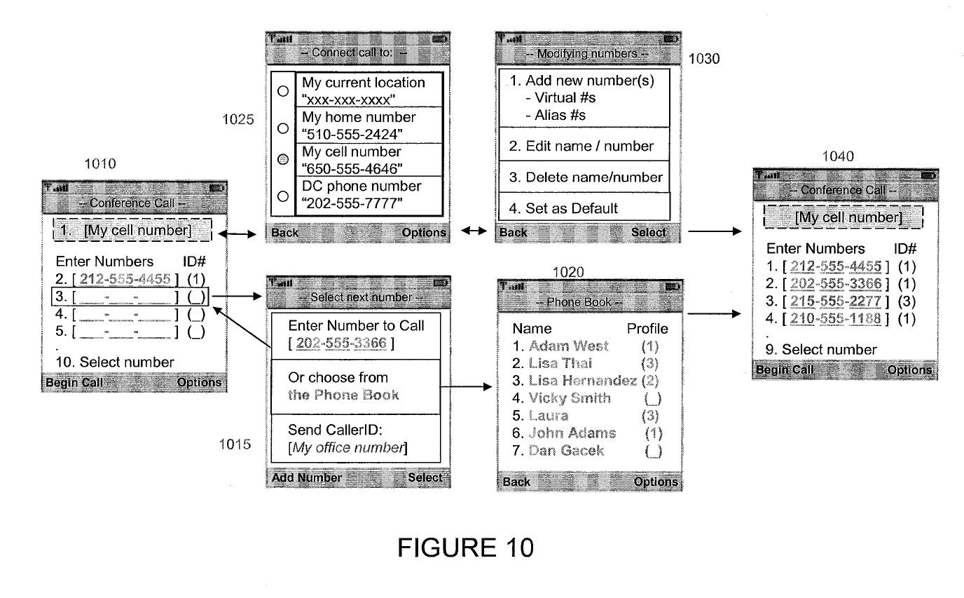

FIG. 10 shows an exemplary series of user interfaces that allows a phone user to initiate a multi-way conference call by simply typing in desired number to be called. In a first user interface 1010, the user is provided with a list of fields that the user can populate with the numbers to be included in the conference call. The user can either manually enter the number or select the number from numbers contained in the contact database 315 or CFD 184, such as through user interfaces 1015 and 1020. The user can also access a user interface 1025 that permits the user to specify the identity (such as a telephone number) from which the call is initiated, as well as a user interface 1030 that permits the user to set up configuration parameters. FIG. 10 shows user interface 1040 with the conference call fields populated with the numbers to be called.

The user may also lookup people to call via a standard phone book (built into the phone 315 or residing on the aliasing system 180/184) lookup feature.

In addition to just placing calls, the application 310 and/or user interface allows different people in one conference call to receive different caller IDs when called. Changing of the caller ID can be performed manually or by the aliasing profiles that are pre-setup on the system 180/184.

The application 310 is also configured to implement automatic group conference calls. In this embodiment, the user (i.e. the subscriber) can add a group identifier to one or more entries in his/her contact database 315 within the phone or within his/her Private Database 145 entries or extended CPD 184. Once group codes have been added, a subscriber can select a single (or multiple) group code(s) and hit the select (or send) key. Such a feature permits a subscriber to establish a conference call with three or more people by selecting a single entry within the phone wherein that entry is associated with a group identifier. In both Conference Calling and Group Conference Calling, the calling party may be required to enter a pass code or press a key on the phone key pad to be added to the conference call. This would prevent non-desired individuals or voicemail systems from being added to a specific conference call.

It should be recognized that any name or number within any one of the contact phone directories (145, 184) may have one or more group codes assigned to it. In this manner, a single entry may be assigned to Group 1, 2 and 3, where group 1 is for “pre-party” members, group 2 is for all party members and group 3 is for the clean-up members only, for example.

Downloadable Call Fact Database

The application 310 is also configured to implement a downloadable call fact database, which can reside at the alias service provider as part of the CFD 184, for example. The call fact database is a database that contains downloadable data associated with telephone numbers that may be called, such as telephone numbers within the contact database 315 or the CFD 184. The data can comprise any type of information, such as addresses, personal information, and can also include multimedia data, such as photos, ringtones, video, etc.

Once the subscriber initiates a phone call, the system may, depending on subscriber options, download information about the party (or parties) being called from the CFD 184. The information being downloaded may also contain pictures of each person being called. This information may be located in the Private Database 145 or the Extended CPD 184. The information contained within the download will be user selectable and will work in either a single call environment or a conference call environment mentioned above.

Automated Conference Call Reminders (ACCR)

In another embodiment, the alias service provider, via the application 310 or the application 185, provides Automated Conference Call Reminders to attendees of an upcoming conference call that has been scheduled via the alias service provider. Such reminders can be triggered by the alias service provider via a voice call, a text message, an email message, by instant message on an alternate network, or via other networks which allow asynchronous notifications. The system may include automatic calendaring notices embedded in the ACCR notifications if that is a user preference, which could be used for automatic calendar system importation. If a user declines participation in a specific call, the application 185 will temporarily modify (or ignore) the declined number during the conference call dialing process.

Automated Profile-Based Dialing (APD)

In another embodiment, the alias service provider provides Automated Profile-based Dialing (APD) capabilities. APD allows a subscriber, through the application 310 or via the Internet using a web browser or via any other type of client/server interface, to preset a method of calling a called party. The user, through a predetermined interface (such as a web interface or a phone interface), can preset a method of calling a phone number that is located within the Contact Database 315 or the Extended CFD 184. Exemplary user interfaces are described below. Pursuant to APD, the user can configure outgoing communications (such as telephone calls) so that certain profile data is used based on the address (such as a telephone number) that is to be accessed. FIG. 8 shows an exemplary series of user interface for implementing such an APD embodiment.

This is sometimes described in the context of making a telephone call using a target telephone number, although it should be appreciated that it is not limited to use within a telephone context.

This might be better understood in the context of an example using the exemplary subscriber profile data shown below. In the example below, the subscriber has 1 or more aliases that can be chosen by the subscriber when calling another subscriber. The APD system, via the application 310 or 180, automatically looks up the profile data parameter for any number that has been dialed through the system and applies an APD method to the outgoing call based on the profile associated with that number. For example, if a subscriber called 415-555-1111, then the APD system automatically assigns profile #1 to the outbound phone call based on previous history of calls. Thus, the phone number 415-555-1111 could be used to populate the caller ID parameters.

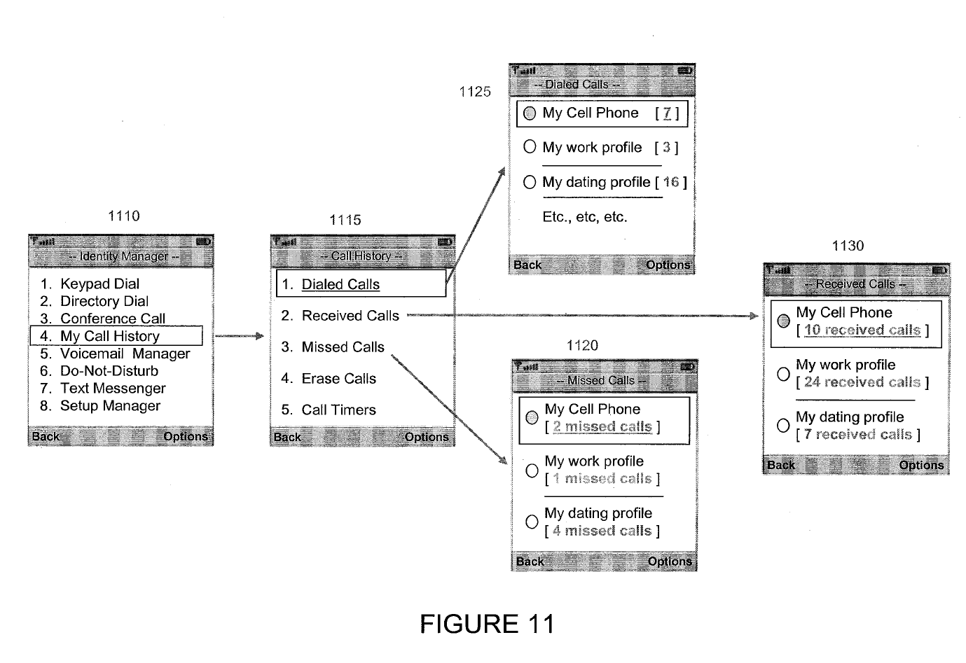

FIG. 11 shows an exemplary user interface for a call history manager that displays call history information that can be grouped pursuant to received calls that pertain to a call profile or group. Instead of just displaying the total number of missed calls as in conventional phones, the user interface shows a list of calls based on profiles to which each call was associated. This way, a user can jump directly to those critical messages associated with a particular profile or group, while leaving the less critical calls to return at a later time. Similar to a normal cell phone history listing, a user can click on any virtual listing and see all of the information for each caller (e.g., name, number and time of date for the call).

With reference to FIG. 11, a first user interface 1110 provides a general menu of items, such as item number 4 that leads to a “Call History” user interface 1015. The user interface 1110 leads to other user interfaces such as a Missed Calls interface 1120, a Dialed Calls interface 1125 and a Received Calls interface 1130. The calls can be grouped according to how the relate to predetermined user profiles.

In another example, if a subscriber called 650-555-5222, then profile 2 would be selected as profile 2 is associated with that number. Other embodiments can include more sophisticated profile dialing, such as the application appending client IDs to calling records and/or automatically recording a phone call and then later forwarding that call to someone's email account.

Such features can be advantageous in certain professions, such as for the legal profession, where adding the client ID to the dialing profile (and later to a generated call log) would allow an attorney to more effectively bill a client for calls made away from his/her office. In another example, a hospital may want to establish a three way conference call between a doctor, a translator and a patient. In this call, the patient ID would be added to the record and the call can be automatically recorded for a number of reasons. Once the call is completed, the application sends the recording (along with the client ID) to the doctor and the translator which may be located in different locations. The APD system can also be configured to act in a predetermined manner for certain phone number prefixes or number match criteria within an endpoint address. For example, if the subscriber were to call any number that began with 650-600 prefix, then the “Block caller ID” flag would be set. This can similarly work on other endpoint addresses, such as SIP URIs, instant messaging identifiers, or other endpoint identification methods.

The APD feature can be overridden on any call by changing a flag or value on the handset or cellular phone.

Exemplary Subscriber Profile Data

| Profile # | Profile Name | Number | Name |
|---|---|---|---|
| 1 | Home | 415-555-1111 | Jeff Black |
| 2 | Work | 650-555-2222 | PartnerVision |
| 3 | Cell | 408-555-3333 | J. Black |
| 4 | Dating | 926-555-4444 | Jeff |
| 6 | Parents | 210-555-5555 | Mr. & Ms. Black |
| 7 | Call Blocking | 415-555-1111 | Restricted/Blocked |
| 8 | Web Phone | jeff@test.net | My SIP identity |

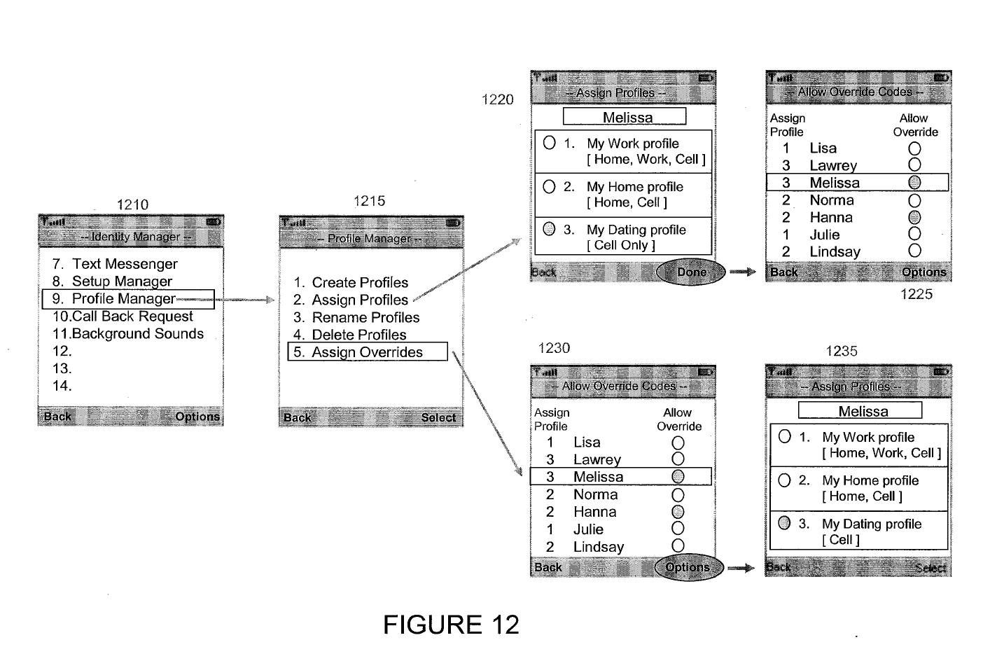

FIG. 12 shows series of exemplary user interfaces that can be used to set-up and manage profiles. From an initial user interface 1210, a Profile Manager interface 1215 can be accessed that presents a menu of profile-related management features. The Profile Manager interface 1215 allows users to setup one or more profiles on the system via user interfaces 1220-1235. For example, each profile can be setup to: 1) ring one or more number when called—in any fashion, like serial or parallel dialing; 2) automatically preset (or modify) an outbound caller ID to a specified number based on a specific profile or group. It should be appreciated that the profile setup can vary as well as the user interfaces associated with the setup.

Selection of Long Distance Service Providers

The alias service provider can act on outgoing communications such that outgoing communications to endpoint addresses are automatically connected over a predetermined network.

For example, telephone numbers dialed out of the telephone are automatically dialed via a predetermined long distance provider. For example, the application 310 can cause the telephone to use a standard Long Distance Provider or to dial a number associated with a long distance service (e.g. such as a “1010” type of long distance service). The application 310 can be configured such that the use of a predetermined long distance provider occurs automatically so that the user is not required to modify his normal phone or cell phone entries. In other words, the user simply selects an entry from the contact database and the application 310 automatically initiates the call through a predetermined long distance provider.

The application 310 can also be configured to dial 4 digit extensions, non-valid phone numbers or alphanumeric words to connect to remote telephone or VoIP users via a standard cell phone. In the case of 4 digit extension dialing, a profile engine in the application maps the 4 digit number found within the phone contact directory 315 or the extended CPD 184 to a full phone number or a VoIP number for dialing purposes. Internet-based address dialing such as by using a VoIP phone with a SIP URI (i.e.: jane@company.com) or instant messaging identity would also be handled via the profile engine since this is a non-standard telephone number for traditional telephone networks. Use of external LDAP directories may also be used to map an short number to an endpoint destination.

It may be possible for the intermediate carrier to be a media type which is not directly corresponding to the originating media type, and furthermore it may be possible for there to be several translations between media types in the path. As an example, a user may purchase a long distance service plan via a VoIP carrier which uses SIP. That long distance carrier would provide a SIP username and password to allow the user to access their account. The user would provide this username/password pair to the alias service provider, who would in turn use that account on behalf of the end user at such time as that end user desired to make calls from their cell phone that utilized the VoIP account. Example rules are least-cost routing, time-of-day routing, destination or origin routing. Other rules are also possible.

Thus, dis-similar endpoint identification methods and media methods can be interconnected via the media proxy. As an example, the user may select via the interface on the device (in this example, a mobile phone) an endpoint identifier such as “user@domain.com”, which is a SIP URI. The media proxy will instruct the mobile phone application to dial a specific telephone number associated with a trunk on the media proxy. The media proxy will then accept that “leg” of the call, and will attempt to create a SIP call “leg” to the given SIP URI. If the SIP RTP session is established with “user@domain.com” then the media proxy will relay the media streams between the two call legs, thus completing the call.

Automated Caller-ID Profile Routing System (APRS):

The application 310 can also be configured to implement profiles that allow a subscriber to automatically route incoming callers to different voicemail boxes (or a single voicemail box that contains different voicemail greetings). This is referred to herein as an Automated Caller-ID Profile Routing System (APRS).

An exemplary profile is shown below for a subscriber Michele. The profile includes a name that is associated with a voicemail box and a comments that generally describes the type of calls that are routed to that voicemail box. For example, voice mail box 1 is for incoming calls from professional clients, while voice mail box 6 is for unwanted calls (i.e., annoying people.) The voicemail greeting for each voicemail box can be particularly tailored for the type of call associated with that box.

Exemplary Profile

| # | Name | Comment |
|---|---|---|
| 1: | Dr. Michele Alison | (Professional Clients) |
| 2: | Michele Alison | (Colleagues) |
| 3: | Michele | (Close Friends) |
| 4: | MJ | (Alias for dating) |
| 5: | “number only” | (All unknown people) |
| 6: | “No Service” | (Annoying People) |

In this exemplary scenario, the user Michele established five different voicemail greetings for a single inbound phone number (e.g., 888-555-1119). It should be appreciated that this scenario is exemplary and that any number of voice mail greetings can be established for any number of inbound phone numbers.

When a call is received by the APRS, a number that is recognized via caller ID would be processed against the user's routing profile. The following is an example of routing rules that can be used.

| Number: | Profile | Pass-through | Pass call to: |
|---|---|---|---|
| 650-555-1111 | 1 | Yes | Cell, Work, Home |
| 212-555-3001 | 2 | Yes | Cell, Home |
| 301-555-7171 | 3 | Yes | Cell |
| 415-555-6969 | 4 | No | |
| ***-***-**** | 5 | No | |
| 327-555-7734 | 6 | No | |
| jane@company.com | 1 | Yes | Work |

In the example above, if Michele receives a call from 650-555-1111, then the call is passed to her cell phone, work phone and home phone all at the same time. The alias service provider has records that define the subscriber's cell, work, and home phone numbers. If the call is answered by Michele (with the correct system response), then that device would get the call. For example: She answered the call on her cell.

On the other hand, if Michele does not properly answer the phone pursuant to the correct response in the rules, then the call will be processed according to the user's APRS profile and routed to a particular voice mail box associated with that number. In this case, the user would receive a voice prompt, for example that “Dr. Michele Alison” is not available and please leave a message. Accordingly, if a call from 301-555-7171 is received, then the call is routed to Michele's cell phone. If there was no answer, then the user would receive a message that “Michele” is not available and please leave a message. Additionally, if Michele receives a call from 415-555-6969 then no attempt would be made to reach Michele and the user would be immediately dropped into voicemail with a message that stated that “MJ” is not available and please leave a message.

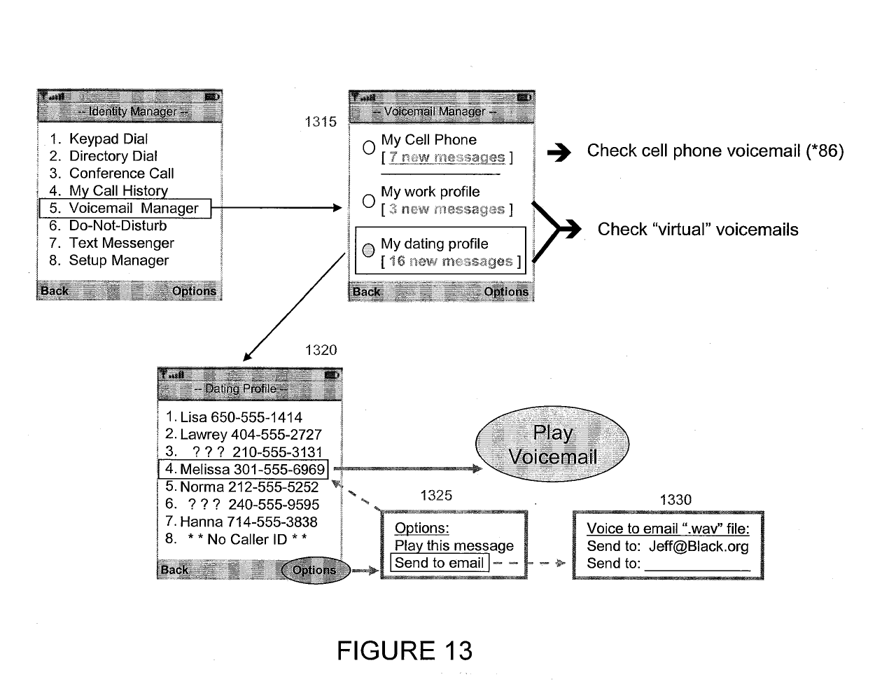

FIG. 13 shows a series of user interfaces that permit a user to access and manage voicemail messages. The voicemail interfaces allow can display a list of voicemails grouped by given profiles or groups. When a user clicks on a profile or group displayed on a user interface (such as user interface 1315, a complete listing of missed calls and/or voice mails for that group is returned (such as in user interface 1320). If a user desires to listen to the 7th message, for example (from Hanna in the UI 1320 in FIG. 13) without listening to the previous voicemails, the user can scroll down the list and select #7 and press a button on the phone associated with play. In addition, if the user desires, a copy of all virtual voicemails is forwarded to a predetermined location, such as an email account for later listening (e.g., from an airplane at 30,000 feet) or simply archived for a user. In addition, a user can forward any voicemail by simply entering in an email address or another telephone number, as represented by diagram boxes 1325 and 1330 in FIG. 13.

If the user specifies, then specific numbers (e.g., 968-555-7734) can be placed on a (BLOCKED) list that will return a message similar to “The number you have reached is no longer in service. No additional information is available at this time.” Lastly, for all other calls (wild-carded) that are not found within the profile list, the users (or callers) would receive a message that stated “The person you are calling” or “the caller you are trying to reach” is not available; Please leave a message after the tone.”

The APRS system can also accommodate direct IP (or Internet Protocol) numbers on both an inbound and an outbound basis. In the example above, if Michele receives a call from SIP URI “jane@company.com” the caller would be transferred to Michele's work number only. Barring any answer by Michele's work number, the caller would receive a voice prompt that is particularly suited for work-related calls. The prompt could state, for example, “Dr. Michele Alison is not available, please leave your name and number and she will call you back during normal business hours. If this is an emergency, then please call 911.”

The APRS is configured to notify the subscriber (e.g., Michele) who is attempting to call her and the subscriber then has the ability to take the call or simply reject it. If the user rejects the call, then the call is pushed back into the voicemail system. If the user decides to take the call, then the device the user is currently on gets the call. In addition, if the user decides to take the call, he/she is allowed to add background noise (or muxed noises) onto the phone line when he/she takes the call, as described above. An example might be that Michele decides to take the call from home, but she wants to add her default hospital background noise to the call to make the caller believe that she is still at the hospital or another user may add conference center background noise when he/she is really on the golf course. The system also allows the user to take the call and have the entire conversation (or a portion thereof) recorded. Any recording that is made can be emailed back to the subscriber and/or caller (if their email address is known to the system).

It should be appreciated that the above rules are exemplary and that the APRS can be configured to implement any of a variety of rules for routing incoming calls. For example, the APRS profiles can also route calls based on other parameters, such as, time of day, user status physical location, and other parameters like Account Number (for professionals such as attorneys). This last scenario would allow any valid client to contact the attorney at home at any time of day or night in case of an emergency. The trigger for routing, for example, can be the client account number.

In addition to conditionally routing multiple calls to the same number(s) into one or more voicemail boxes with different voice prompts, the system can also route multiple phone numbers into one voicemail box with one or more voicemail prompts. This allows the user above (such as Michele) to have her Home, Cell and Work numbers screened by the profiling system above. The APRS allows the same in-bound caller ID numbers to be profiled the same way and all messages could be put in the same voicemail box regardless of the number dialed by the same inbound user.

Background Noise

As mentioned, the alias service provider is configured to insert background noise into the call such that the called party will hear the background noise as a background to the calling party's voice during the call. The background noise can vary. For example, the background noise can make it appear that the caller is calling from a cell phone, can provide static, can provide “outside” noises to make it appear that the caller is outside, etc.

Any type of background noise can be used to make it appear that the caller is calling from a certain location or from a certain environment. For example, the alias service provider can insert background noises typically associated with a hospital, airport, or convention center. The alias service provider can maintain a background noise database 183 (FIG. 4) comprised of pre-canned selections. Alternately, the subscriber may upload his/her own background noises to the Background Noise Database 183 (as seen in FIG. 4) from his/her PC or phone 110.

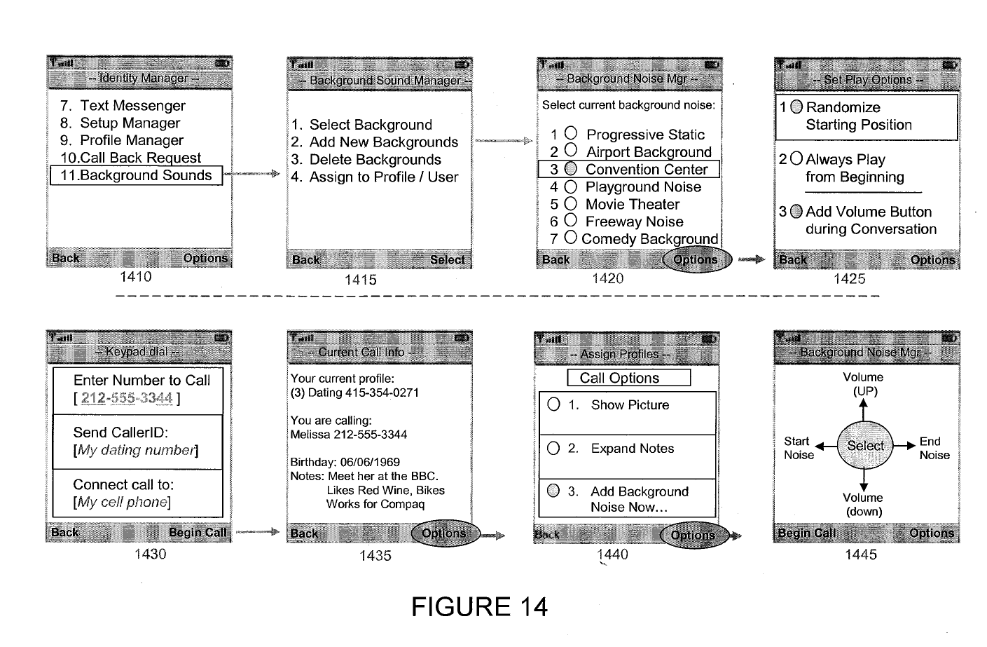

FIG. 14 shows a series of exemplary user interfaces for configuring background noise for calls. A Background Sound Manager interface 1415 is accessed from an Identity Manager interface 1410. The interface 1415 presents the user with a menu of features that can be selected to configure the background noise, if any, for a call. For example, an interface 1420 can be used to select the type of background noise, while an interface 1425 configures the background noise. Background noises are stored within the Alias Service Provider and may be used for both inbound and outbound calling.

Advanced Message Notification (AMN):

The application 310 or 185 is also configured to implement a feature referred to as Advanced Message Notification (AMN). Pursuant to AMN, the application notifies the subscriber when a call or voicemail arrives from a predetermined caller. This permits the subscriber to know when a new voicemail has arrived and to be notified (via the Caller ID feature) what caller is being transferred to the subscriber.

The AMN system can also notify a subscriber that a priority message has arrived based on the APRS system default profiles, described above. In other words, Michele could be notified via an automated response system or a text messaging or email system that she had just received a call from someone on her dating profile even though all such calls always go directly into her virtual voicemail system. Secondly, this same feature can be used to clarify the name or other attributes of a live transferred call. In this case, the APRS system can append or prefix additional information to (or replace entirely) the Caller ID information that belongs to the originating caller. Lastly, the AMN system may replace the caller ID information with predetermined indicia. For example, the AMN system can notify the subscriber Michele that she has just received a voice message from “boyfriend” instead of the person's real name.

Voicemail and Call Tracking (CT)

The application 310 or 180 includes a Voicemail and Call Tracking (CT) engine that enables the application to track remote calls to other assigned numbers to a subscriber in a similar way to how conventional cell phones track in-bound, out-bound, missed calls, and voicemails today. One exemplary difference is, the application 310 allows the subscriber to see this information for one (or more) remote phone numbers that are not directly assigned to that cell phone. This would allow Michele to see that she had 69 voicemails in her dating mailbox and 6 missing calls from phone number “926-555-4444”. The CT engine communicates with the application 310 via a wireless network connection on a when-available basis.

Presence Dialing and Proximity Based Predictive Dialing for dial-in services:

The application is configured such that a subscriber can set his or her profile to ignore calls based on the physical location of the subscriber and/or time of day (or day of the week). The criteria for ignoring particular calls can be defined in a database associated with the subscriber wherein the database resides at the alias service provider. Alternately, the application is configured to user different versions of subscriber profile databases for the subscriber based on various criteria, such as the time of day, the subscriber's location, time of year, etc.

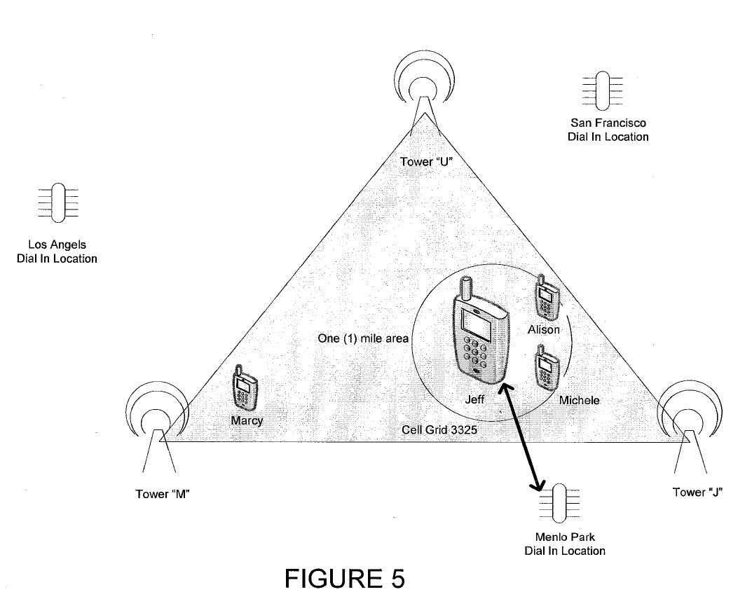

For example, exemplary subscriber Jeff could restrict all calls (or selective calls) within his profile from reaching him via one or more of his phone numbers whenever he approaches his physical work or home location. As represented in FIG. 5, the application within the phone tracks the physical location of the subscriber using well-known location tracking methods and devices. When the subscriber approaches a known location, the dialing profiles within the subscriber's control may change.

In addition, the ability to control calls via presence (or location) can be tied into standard databases, day-timers or related applications. Lastly, the “presence dialing” feature enables exemplary subscriber Jeff to call or text message anyone (or everyone) that was within his contact database which was currently within a one mile radius (or some other distance) of his current position. This form of presence dialing is envisioned as being useful for people that are dating or just ad hoc groups that wish to communicate based on their current proximity to each other.

In order to access the alias service provider, the subscriber's phone can call a service number associated with the service provider. In one aspect, the application 310 is configured to locate the most efficient (either from a physical or monetary standpoint, for example) dial-in service number before it dials an alias service provider. The application 310 performs such a task via conventional cellular tower triangulation or though a common method of GPS (or assisted GPS) positioning (as represented in FIG. 5). Once the cell phone's location is determined, a lookup table is accessed by the application and used to identify the closest dial-in locations for the phone to call, thus reducing local and long distance charges to the user.

It should be understood that the system may allow a user to select a dial-in number from a list of numbers. In the example in FIG. 5, Jeff's cell phone correctly locates the closest dial-in service in Menlo Park. This ability to automatically locate the closest dial-in facility saved exemplary subscriber Jeff from guessing which facility is closest to his location. In addition, this automated location service also saved Jeff from potentially dialing a long distance number to reach a service that actually had a local dial-in number. This service would save Jeff in long distance costs.

As in Group Conference Calling, subscriber may dial a group call, but limit or restrict all numbers that are located more than a certain distance from the subscriber. In FIG. 5, for example, Jeff (the subscriber) initiates a conference call with group 1 which contains Marcy, Michele and Alison and Jeff specified that a 1 mile radius limit should be associated with the call. Since Jeff selected a 1 mile radius, only Michele and Alison were connected to the call. Marcy is outside the 1 mile radius and so the application 310 automatically excludes Marcy from the call.

It should be noted that the application 310 within the phone will selectively pull local dial-in phone numbers on an ad hoc basis over a wireless network connection. Depending on the available memory and user selections, the application 310 may download more, or fewer, numbers.

Lastly, the application may also contain alternative default dial-in numbers like toll free numbers or default number in specific countries where local service may, or may not, be available.

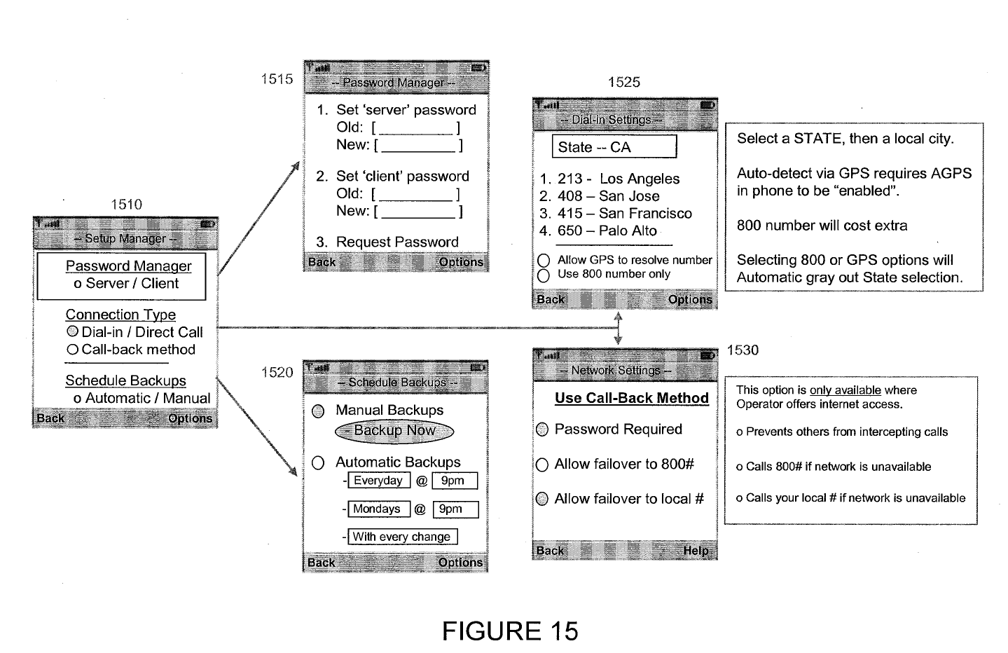

FIG. 15 shows an exemplary series of user interfaces for setting up proximity based dialing parameters and other configuration parameters. An initial user interface 1510 includes selectable menu items that lead to additional user interfaces, such as a password manager interface, a scheduled backup interface 1520, and connection type interfaces 1525 and 1530.

To connect a user to the closest dial-in point, the system can allow a user to select the closest dial-in location or to specify that the AGPS (or GPS) within the phone may be activated to automatically find the closest dial-in point. In the situation where a simple tower number is available, the system can also use this parameter to find the closest dial-in point. Although this is not as accurate as using the GPS positioning in the phone (or cellular network), it is close enough in most cases to find a location number for the phone to call.

In another embodiment, the alias service provider system enables subscribers to be called back anywhere in the world and then turn control of the session over to the called party. The system can cause a pre-recorded message to be played when the call is answered. This message may ask for a specific person (e.g., when calling your hotel room through a switchboard) or it may ask the called party for a security pass-code to relinquish control over to the called party. At this point in time, the user is connected back into the main system as if he/she had called in directly, but without the cost associated with it.

Emergency Out-of-Service (EOS) option

A subscriber may, through the application 310 within his phone or through dialing into the alias service provider, turn on an Emergency Out-of-Service (EOS) option. The EOS option causes the subscriber's phone to immediately give predetermined callers (such as all callers, or just selected groups of callers, or just unknown callers) the impression that this phone number had been discontinued or pulled out of service. This feature would allow a subscriber to quickly remove all evidence of his use of a particular phone number on a temporary basis.

Sponsor-a-Call Advertising:

Prior to a subscriber actually completing a phone call, he/she may have an option to hear a downloaded advertisement wherein the alias service provider downloads the advertisement to the subscriber's phone. If the subscriber chooses to listen to the entire advertisement, then the advertiser may pick up the cost of the subscriber's call or a portion of the subscriber's call. To verify the ad was heard, the subscriber may have to type in a code that was broadcast during the advertisement or other verification methods which relate the advertisement to the product or the content of the advertisement itself. This type of advertisement may be also present on outbound calls, which would require called destinations to listen to an advertisement before completely connecting a call from a subscriber.

Banner Advertisements:

The application 310 may employ some form of banner advertisement while the application is being utilized. These banner ads would be downloaded over a wireless network connection to the phone on a regular basis. If the user's location is known via GPS or other means, then the advertisements may be localized to the user's current position. The application 310 may also act as a background screen manager (e.g. a wall paper application) where downloadable ads can be displayed as the default screen background or ads (which may be icons) may also be displayed the outside window of a person's cell phone while the phone is now being used. Once the user agrees to effectively turn his/her phone into a walking billboard, the advertiser (e.g., Nike) may be willing to pay for a portion of the users phone bill. (Note: On a flip phone, the would allow an advertiser to place an ad on smaller outside window while the person is walking around and a larger ad on the main screen when the phone is open.

Verification System (VS):

The alias service provider may employ a Verification System (VS) feature that would allow suspecting victims of a harassing or otherwise undesired recent phone call to verify if they have received any calls from an alias service provider system. For example, if phone 115 received several phone calls from a person pretending to be an insurance person, the operator of phone 115 would be able to call into one the alias service provider systems to check if any alias service provider subscribers had called the phone 115 within a certain period of time. It should be noted that the operator of phone 115 would not have to be a subscriber to the alias service provider. This features would simply inform individuals if they have be contacted by anyone using an alternative identity. To verify that the requesting party is truly located at the phone number which they wish to check, the system would dial back the requestor immediately following the request. The alias service provider may associate a fee with this lookup request. There would be an automated method of inquiry to the same results made available to law enforcement agencies. The alias service provider may create a “blacklist” which forbids identity-modified calls from reaching certain numbers on a global basis (across all users.) This blacklist may be managed by a centralized arbiter, or may be modified by individuals.

Alias Phone Number Verification (APNV):

Similar to the SVS system, the APNV system is designed to verify that a subscriber has authorization over a particular phone number before it allows a number to be added to the subscriber's available outbound calling directory. For instance, if a subscriber 110 wants to add another phone number 115 to his/her alias list for out-bound dialing, the system (or application 185) would issue the subscriber 110 a pass code to use to activate that number within the database. One the pass code has been assigned to the subscriber, the system would terminate the call and redial the requested (115) number. Upon answering the phone, the subscriber would have to enter the correct pass code within a certain number of tries or the number would be not be added to the subscriber's calling list. In some cases, the subscriber may request a call back time or a call back delay to allow him/her to be physically at the phone when the verification call is made.

Name Directory Lookup (NDL):

The alias service provider also can implement a Name Directory Lookup (NDL) feature. Pursuant to the NDL feature, the user looks up a name within the cell phone application 310, which could be connected to a traditional yellow page engine or a custom or private phone directory. In one instance, the NDL 182 engine may contain information on residents in a small community. Once the end-name is chosen, the phone would read the phone number and automatically dial the number. In this case, the phone could either dial the number directly through the phone or through the alias service provider or another local long distance provider.

In another embodiment of the NDL 182 engine, people or businesses may be able to self-register themselves. This would be similar to a standard yellow page application, but users and businesses will be self registering themselves. This system may contain more than one NDL engine or database 182. Various NDL databases may be used for specialty applications like dating. Adds, Deletes and Changes would also be controlled by the users or businesses.

Automated ENUM

The alias service provider is also configured to implement an Automated ENUM feature. The automated ENUM system enables a subscriber to automatically verify a number being called against an ENUM database to identify if this number has a corresponding VoIP service or phone number. In the case where a VoIP address exists, the call would be processed via VoIP protocols. If the ENUM test failed, then the phone call would be processed as a normal phone call through the alias service provider. ENUM is specified in the IETF document RFC #2916.

Selective Do-Not-Disturb (DND):

Pursuant to a Selective Do-Not-Disturb (DND) feature, the application 310 configures the phone to be set to a do-not-disturb status based on data associated with an incoming call. Thus, DND can be set on an individual basis. Conventional cell phones and VoIP phones that support Do-Not-Disturb features apply this feature to all calls during a certain period. The alias service provider enables a user to set selectively (via the subscriber's profile) the DND feature. In an example, Michele could selectively turn on the DND feature for certain classes of calls (or calls from a selected caller) during certain times of the day or whenever her presence/location changes.

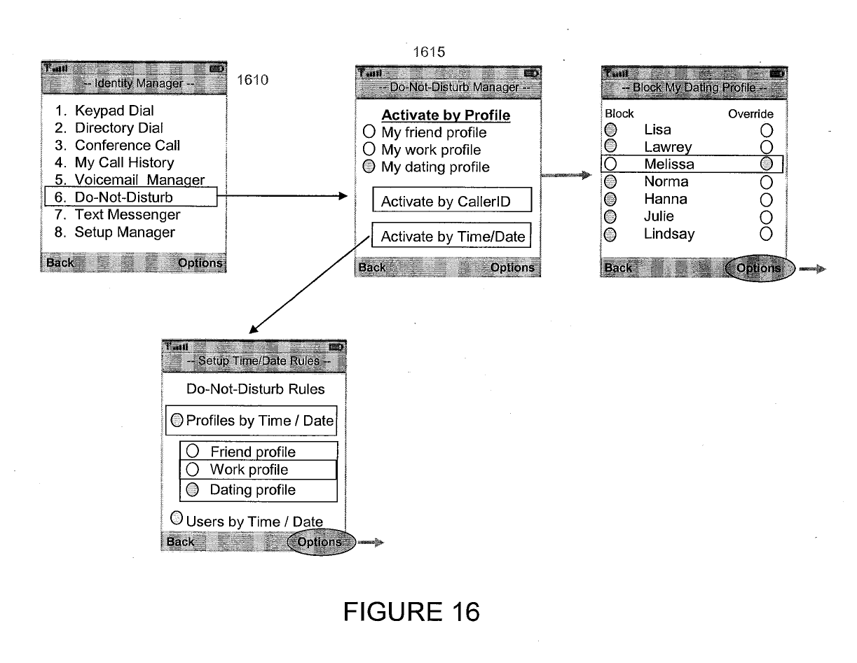

FIG. 16 shows a series of user interfaces that can be used to manage a Selective Do-Not-Disturb feature. An initial user interface 1610 includes menu items including menu item “6” that leads to a Do Not Disturb Manager interface 1215. The Do-Not-Disturb Manager interface 1615 displays a list of profiles that can be set to Do-Not-Disturb mode either on an entire profile basis or for individual numbers within the profile. Thus, the user can selectively put one or more profiles into do-not-disturb mode. This can be done manually or automatically by time of date, or other preset conditions.

When any profile is activated, the users has the ability to setup an override setting that allows individuals in blocked (or temporally blocked) profile or groups to bypass this mode and ring on the desired phone/number as if the user was not part of a block group.

In addition, the override flag may also cause a warning (or prompt) to be played to any user within an override status (while currently enabled) to tell the user that the cell phone user is currently in do-not-disturb mode. The system may simply warn the caller or ask the caller if he/she wishes to still be connected to the called party.

There may exist also a global setting to allow a user to block all of a calling profile at once or a user may block each individual profile (or specified caller ID) on an individual basis.

Alias Communication Protocol (ACP):

It is understood that the applications 310 (FIG. 3A) may establish a connection with the alias service provider 180 through either a tone-based protocol over traditional phone lines 161 (including cellular connections) or via a wireless network connection 162 using a protocol like TCP/IP or similar.

In any event, all forms of communications referenced above between a subscriber 115 and an end user 110, including all applications (e.g., 310, 325, 145, 181, 182, 183, 184, 185, etc.) in-between, may use either phone lines 161 or wireless network connections 162 to effectuate one or more calls. In some cases, both forms of connections may be used simultaneously.

An example of the latter could be a subscriber 115 generating a ten-way conference call where the application 310 connects to the alias service provider 180 via a wireless network connection 162 to establish the call setup parameters and then the alias service provider 180 communicates back with the subscriber 115 via a phone line (or wireless phone connection) 161 to complete the call.

In another embodiment, where the call setup is less demanding, the application 310 may complete the entire call setup and dialing process over a traditional phone line 161 (or cellular connection). In this case, a tone-based handshaking protocol would be used.

Lastly, it should be understood that the majority of the steps found within FIG. 2B may, in some cases, simply reside within the alias service provider's systems, instead of the subscriber's application 310 or contact database 315. For example, if a subscriber 110 calls another subscriber 115 from a pay phone, the subscriber may only be required to log into the service and then dial the subscriber 115 he/she wishes to call. In this embodiment, the system simply uses the call setup defaults found within the subscriber's profile for the called party 115.

Call Cost Manager

The alias service provider provides a Call Cost Manager feature that allows a user to enter a phone number into a phone and receive a proposed charge for the alias service provider to implement the call. Instead of actually dialing the number, the system automatically prices the phone call based on what the call might cost at that moment. In addition, the system prices out a per minute charge and an estimated (or exact) price for a call over an exact duration. The start/end time of the calls, the time of day, the underlying network, quality preferences, and any other characteristic of the call (including services offered by the service provider) may be included in the price quote.

A number of embodiments of the invention have been described. Nevertheless, it will be understood that various modifications may be made without departing from the spirit and scope of the invention. Accordingly, other embodiments are within the scope of the disclosure.

What is claimed:

1. A method of establishing a conference call, comprising:
identifying two or more participants of a conference call;
providing a conference call notification to each of the two or more participants, wherein the conference call notification includes an identifier descriptive of an originator of the conference call; and
varying the identifier for each participant that receives the notification.

2. A method as in claim 1, wherein the identifier is a caller ID.

3. A method as in claim 1, wherein the conference call notification is automatically provided based on a profile.

4. A method as in claim 3, wherein the profile includes rules that vary based on the participant identified for the conference call.

5. A method as in claim 1, further comprising displaying a graphical user interface that permits a user to identify the two or more participants and to identify the identifier for each participant.

6. A method as in claim 1, wherein the two or more participants are identified using an address data base.

7. A method of initiating a conference call, comprising:
presenting a graphical user interface (GUI) on handset, wherein the GUI includes at least one field for providing a conference call participant and at least one field for providing an originating identification to be provided in a notification to the conference call participant, wherein the originating identification is associated with an originator of the conference call.

8. A method as in claim 7, wherein the graphical user interface permits the conference call participant to be selected from digital phone book.

9. A method as in claim 7, wherein the originating identification is a caller ID.
